(19) United States
(12) Patent Application Publication
(10) Pub. No.: US 2010/0323778 A1
(43) Pub. Date: Dec. 23, 2010

(54) Gaming Machine

(75) Inventor: Kazumasa YOSHIZAWA, Tokyo (JP)

Correspondence Address: NDQ&M WATCHSTONE LLP, 300 NEW JERSEY AVENUE, NW, FIFTH FLOOR, WASHINGTON, DC, 20001, US

(73) Assignee: ARUZE CORP., Tokyo (JP)

(21) Appl. No.: 12/562,327

(22) Filed: Sep. 18, 2009

Related U.S. Application Data
(60) Provisional application No. 61/097,933, filed on Sep. 18, 2008.

(51) Int. Cl. A63F 9/24; A63F 13/00

(52) U.S. Cl. 463/20; 463/30

(57) ABSTRACT

A gaming machine according to the present invention executes a main game and a sub game in parallel. In sub game processing, the gaming machine judges whether or not the number of times the main game is executed is a predetermined number (S122, S125). In a case where the number is not a predetermined one, the gaming machine stores symbols having been displayed in a stopped manner on a payline L1, thereby displaying them on an upper image display panel. The gaming machine determines a payline L2 for showing a winning combination (S128) and displays the determined payline L2 (S129) during a period from execution of at least one or more main games to execution of the predetermined number of main games. Specifically, the payline L2 determined at S128 is displayed so as to be superimposed on a symbol matrix of the upper image display panel. In a case where the number is a predetermined one, the gaming machine judges whether or not a winning combination for awarding a prize is established (S132). In a case where the winning combination is judged to be established, the gaming machine determines a payout amount in accordance with a given prize (S133).

### BACKGROUND OF THE INVENTION

1. Field of the Invention

The present invention relates to a gaming machine and, more particularly, to a gaming machine for executing a main game and a sub game in parallel, in which the main game is executed with use of a plurality of reels and the sub game is executed based on a displayed outcome of the main games executed the predetermined number of times.

2. Description of the Related Art

Conventionally, there have been known gaming machines, wherein: a game is started after a player has betted the predetermined amount; rotation of plural reels having a plurality of symbols drawn thereon is started and stopped after an elapse of a predetermined period of time; and, as the result of the stoppage, a prize is awarded based upon a combination of symbols on the reels displayed in a stopped manner. Examples of gaming machines of such type are disclosed in U.S. Pat. Nos. 6,960,133-B1 and 6,012,983.

However, in the conventional games, players are entertained merely with an increase or a decrease in the amount of gaming media or money. In the case of continuous play, most of the players are likely to lose the gaming media or money at an unfortunate time. A need exists for the advent of gaming machine of socially acceptable time-consumption type that entertains the players even in processing of determining a winning combination for prize award, by showing them not only an outcome (an increase or a decrease in the amount of gaming media or money) but also this determination processing.

The present invention has been made in view of the above-described circumstance. It is an object of the present invention to provide a novel gaming machine with new entertainability.

### SUMMARY OF THE INVENTION

A first aspect of the present invention is a gaming machine including: (i) a first display device that is intended for a main game and on which plural types of symbols are rearranged in a display region every time the main game is executed; (ii) a second display device that is intended for a sub game; forms a symbol matrix in association with an arrangement outcome of the symbols rearranged in the display region on the first display device, every time the main game is executed on the first display device a predetermined number of times; and shows an outcome of the sub game by displaying a payline on the symbol matrix; (iii) a memory that stores data concerning the symbols rearranged in the display region on the first display device, every time the main game is executed the predetermined number of times, and stores a game number as a number of times that the main game is executed; and (iv) a controller. The contorller is configured to: (a) execute the main game in which the plural types of symbols are rearranged in the display region on the first display device; (b) determine whether to award a first prize in accordance with a displayed outcome of the plural types of symbols rearranged in the process (a), in the display region on the first display device; (c) award the first prize as a prize for the main game, in a case where the the first prize is determined to be awarded as a result of the process (b), and then activate a subsequent main game; or activate the subsequent main game, in a case where the first prize is determined not to be awarded as a result of the process (b); (d) execute the sub game in parallel with the main game executed in the processes (a) to (c) on the first display device, the sub game in which the symbol matrix is formed by arranging in the second display device based upon the data stored in the memory, the symbols rearranged in the display region on the first display device every time the main game is executed on the first display device the predetermined number of times; (e) judge based upon data concerning the game number stored in the memory, whether the predetermined number of main games executed in the processes (a) to (c) have been executed; (f) display the payline on the symbol matrix of the second display device during a period from execution of the at least one or more main games to execution of the predetermined number of main games, upon judging that the predetermined number of main games have been executed; (g) judge whether the symbols for awarding a second prize are displayed on the payline on the symbol matrix of the second display device; (h) award the second prize as a prize for the sub game, upon judging as a result of the process (g) that the second prize is to be awarded; and (i) initialize the game number for the main game, stored in the memory.

According to the first aspect of the present invention, the controller determines whether to award a prize for the sub game executed on the second display device, based upon an outcome of symbol rearrangement executed on the first display device by the predetermined number of times, and a payline set on the second display device. In this manner, the gaming machine with new entertainability can be provided, in which, in addition to the main game executed on the first display device, the sub game is executed on the second display device based upon different payline-judgment, in association with an outcome of the main games executed the predetermined number of times.

A second aspect of the present invention is a gaming machine constituted as set forth below. In the first aspect, the controller displays the payline on the symbol matrix of the second display device during a period from completion of execution of one less than the predetermined number of main games to display of an outcome of the predetermined number of main games, upon judging in the process (f) that the predetermined number of main games have been executed.

According to the second aspect of the present invention, the payline is displayed on the symbol matrix of the second display device after main games whose number is one less than predetermined number thereof have been executed. In this manner, the payline can be displayed on the second display device in a state before symbols are lined up in a winning combination for prize award.

A third aspect of the present invention is a gaming machine constituted as set forth below. In the first aspect, the controller stores in the memory, a result of random determination of the predetermined number of main games; and executes the sub game in the process (d) based upon the predetermined number of main games stored in the memory, in parallel with the main game executed on the first display device in the processes (a) to (c).

According to the third aspect of the present invention, the sub game is executed in parallel with the main game, based upon the randomly-predetermined number of main games. In this manner, a prize for the sub game can be unexpectedly awarded to a player.

A fourth aspect of the present invention is a gaming machine constituted as set forth below. In the first aspect, the controller: randomly predetermines a given payline from among the plurality of paylines that are settable on the symbol matrix of the second display device; and executes the process (f) so as to display the randomly-predetermined given payline on the symbol matrix of the second display device.

According to the fourth aspect of the present invention, one payline is randomly predetermined from among the plurality of paylines that can be set on the symbol matrix of the second display device. In this manner, a player can have expectations for uncertainties.

A fifth aspect of the present invention is a gaming machine constituted as set forth below. In the first aspect, the gaming machine further includes an input device for selecting a given payline from among the plurality of paylines that are settable on the second display device. The controller executes the process (f) based upon a result of the selection of the given payline by the input device, so as to display the selected given payline on the symbol matrix of the second display device.

According to the fifth aspect of the present invention, the player selects one payline through the input device. The player can extend his/her strategy for the game, by arbitrarily selecting a payline on the symbol matrix of the second display device.

A sixth aspect of the present invention is a gaming machine constituted as set forth below. In the first aspect, the controller: predetermines a given payline to be set on the first display device; sets the predetermined given payline on the first display device; stores the symbols rearranged on the payline set on the display region on the first display device, every time the main game is executed the predetermined number of times; and executes the sub game in the process (d) in parallel with the main game executed in the processes (a) to (c) on the first display device, the sub game in which the symbol matrix is formed by arranging in the second display device based upon the data stored in the memory, the symbols rearranged on the payline set on the display region on the first display device every time the main game is executed on the first display device the predetermined number of times.

According to the sixth aspect of the present invention, the predetermined payline is randomly set on the first display device. In this manner, the payline can be variously changed on the first display device.

A seventh aspect of the present invention is a gaming machine constituted as set forth below. In the first aspect, the gaming machine further includes an input device for selecting a given payline from among the plurality of paylines that are settable on the first display device. The controller: sets the selected given payline on the display region of the first display device, based upon a result of the selection of the given payline by the input device; stores in the memory the symbols rearranged on the payline set on the display region on the first display device, every time the main game is executed the predetermined number of times; and executes the sub game in the process (d) in parallel with the main game executed in the processes (a) to (c) on the first display device, the sub game in which the symbol matrix is formed by arranging in the second display device based upon the data stored in the memory, the symbols rearranged on the payline set on the display region on the first display device every time the main game is executed on the first display device the predetermined number of times.

According to the seventh aspect of the present invention, one payline selected from among the plurality of paylines that can be set on the first display device is set in the display region of the first display device. In this manner, the player can extend his or her options for the game.

An eighth aspect of the present invention is a gaming machine including: (i) a first display device that is intended for a main game and on which plural types of symbols are rearranged in a display region every time the main game is executed; (ii) a second display device that is intended for a sub game; forms a symbol matrix in association with an arrangement outcome of the symbols rearranged in the display region on the first display device, every time the main game is executed on the first display device a predetermined number of times; and shows an outcome of the sub game by displaying a payline on the symbol matrix; (iii) a memory that stores data concerning the symbols rearranged in the display region on the first display device, every time the main game is executed the predetermined number of times, and stores a game number as a number of times that the main game is executed; and (iv) a controller. The contorller is configured to: (a) execute the main game in which the plural types of symbols are rearranged in the display region on the first display device; (b) determine whether to award a first prize in accordance with a displayed outcome of the plural types of symbols rearranged in the process (a), in the display region on the first display device; (c) award the first prize as a prize for the main game, in a case where the the first prize is determined to be awarded as a result of the process (b), and then activate a subsequent main game; or activate the subsequent main game, in a case where the first prize is determined not to be awarded as a result of the process (b); (d) execute the sub game in parallel with the main game executed in the processes (a) to (c) on the first display device, the sub game in which the symbol matrix is formed by arranging in the second display device based upon the data stored in the memory, the symbols rearranged in the display region on the first display device every time the main game is executed on the first display device the predetermined number of times; (e) judge based upon data concerning the game number stored in the memory, whether the predetermined number of main games executed in the processes (a) to (c) have been executed; (f) display the payline on the symbol matrix of the second display device during a period from completion of execution of main games whose number is one less than the predetermined number to display of an outcome of the predetermined number of main games, upon judging that the predetermined number of main games have been executed; (g) judge whether the symbols for awarding a second prize are displayed on the payline on the symbol matrix of the second display device; (h) award the second prize as a prize for the sub game, upon judging that the second prize is awarded, as a result of the processes (g); and (i) initialize the game number for the main game, stored in the memory.

According to the eighth aspect of the present invention, the controller determines whether to award a prize for the sub game executed on the second display device, based upon an outcome of symbol rearrangement executed on the first display device by the predetermined number of times, and a payline set on the second display device. In this manner, the gaming machine with new entertainability can be provided, in which, in addition to the main game executed on the first display device, the sub game is executed on the second display device based upon different payline-judgment, in association with an outcome of the main games executed the predetermined number of times. Further, the payline is displayed on the symbol matrix of the second display device after main games whose number is one less than a predetermined number has been executed. Thus, the payline can be displayed on the second display device in a state before symbols are lined up in a winning combination for prize award.

A ninth aspect of the present invention is a gaming machine constituted as set forth below. In the eighth aspect, the controller: stores in the memory, a result of random determination of the predetermined number of main games; and executes the sub game in the process (d) based upon the predetermined number of main games stored in the memory, in parallel with the main game executed on the first display device in the processes (a) to (c).

According to the ninth aspect of the present invention, the sub game is executed in parallel with the main game, based upon the randomly-predetermined number of main games. In this manner, a prize for the sub game can be unexpectedly awarded to a player.

A tenth aspect of the present invention is a gaming machine constituted as set forth below. In the eighth aspect, the controller: randomly predetermines a given payline from among the plurality of paylines that can be set on the symbol matrix of the second display device; and executes the process (f) so as to display the randomly-predetermined given payline on the symbol matrix of the second display device.

According to the tenth aspect of the present invention, one payline is randomly predetermined from among the plurality of paylines that can be set on the symbol matrix of the second display device. In this manner, a player can have expectations for uncertainties.

An eleventh aspect of the present invention is a gaming machine constituted as set forth below. In the eighth aspect, the gaming machine further includes an input device for selecting a given payline from among the plurality of paylines that can be set on the second display device. The controller executes the process (f) based upon a result of the selection of the given payline by the input device, so as to display the selected given payline on the symbol matrix of the second display device.

According to the eleventh aspect of the present invention, the player selects one payline through the input device. The player can extend his/her strategy for the game, by arbitrarily selecting a payline on the symbol matrix of the second display device.

A twelfth aspect of the present invention is a gaming machine constituted as set forth below. In the eighth aspect, the controller: predetermines a given payline to be set on the first display device; sets the predetermined given payline on the first display device; stores the symbols rearranged on the payline set in the display region on the first display device, every time the main game is executed the predetermined number of times; and executes the sub game in the process (d) in parallel with the main game executed in the processes (a) to (c) on the first display device, the sub game in which the symbol matrix is formed by arranging in the second display device based upon the data stored in the memory, the symbols rearranged on the payline set on the display region on the first display device every time the main game is executed on the first display device the predetermined number of times.

According to the twelfth aspect of the present invention, the predetermined payline is randomly set on the first display device. In this manner, the payline can be variously changed on the first display device.

A thirteenth aspect of the present invention is a gaming machine constituted as set forth below. In the eighth aspect, the gaming machine further includes an input device for selecting a given payline from among the plurality of paylines that are settable on the first display device. The controller: sets the selected given payline on the display region of the first display device, based upon a result of the selection of the given payline by the input device; stores in the memory the symbols rearranged on the payline set on the display region on the first display device, every time the main game is executed the predetermined number of times; and executes the sub game in the process (d) in parallel with the main game executed in the processes (a) to (c) on the first display device, the sub game in which the symbol matrix is formed by arranging in the second display device based upon the data stored in the memory, the symbols rearranged on the payline set on the display region on the first display device every time the main game is executed on the first display device the predetermined number of times.

According to the thirteenth aspect of the present invention, one payline selected from among the plurality of paylines that can be set on the first display device is set in the display region of the first display device. In this manner, the player can extend his/her options for the game.

A fourteenth aspect of the present invention is a gaming machine including: (i) a first display device that is intended for a main game and on which plural types of symbols are rearranged in a display region every time the main game is executed; (ii) a second display device that is intended for a sub game; form a symbol matrix in association with an arrangement outcome of the symbols rearranged in the display region on the first display device, every time the main game is executed on the first display device a predetermined number of times; and shows an outcome of the sub game by displaying a payline on the symbol matrix; (iii) a memory that stores data concerning the symbols rearranged in the display region on the first display device, every time the main game is executed the predetermined number of times, and stores a game number as a number of times that the main game is executed; and (iv) a controller. The contorller is configured to: (a) randomly determine the game number for the main game executed on the first display device, and stores the determined game number in the memory; (b) execute the main game in which the plural types of symbols are rearranged in the display region on the first display device; (c) determine whether to award a first prize in accordance with a displayed outcome of the plural types of symbols rearranged in the process (b), in the display region on the first display device; (d) award the first prize as a prize for the main game, in a case where the the first prize is determined to be awarded as a result of the process (c), and then activate a subsequent main game; or activate the subsequent main game, in a case where the first prize is determined not to be awarded as a result of the process (c); (e) execute the sub game in parallel with the main game executed in the processes (b) to (d) on the first display device, the sub game in which the symbol matrix is formed by arranging in the second display device based upon the data stored in the memory, the symbols rearranged in the display region on the first display device every time the main game is executed on the first display device the predetermined number of times; (f) judge based upon data concerning the game number stored in the memory, whether the predetermined number of main games executed in the processes (b) to (d) have been executed; (g) display the payline on the symbol matrix of the second display device during a period from execution of the at least one or more main games to execution of the predetermined number of main games, upon judging that the predetermined number of main games have been executed; (h) judge whether the symbols for awarding a second prize are displayed on the payline on the symbol matrix of the second display device; (i) award the second prize as a prize for the sub game, upon judging as a result of the process (g) that the second prize is to be awarded; and (j) initialize the game number for the main game, stored in the memory.

According to the fourteenth aspect of the present invention, the controller determines whether to award a prize for the sub game executed on the second display device, based upon an outcome of symbol rearrangement executed on the first display device by the predetermined number of times, and a payline set on the second display device. In this manner, the gaming machine with new entertainability can be provided, in which, in addition to the main game executed on the first display device, the sub game is executed on the second display device based upon different payline-judgment, in association with an outcome of the main games executed the predetermined number of times. Further, the sub game is executed in parallel with the main game, based upon the randomly-predetermined number of main games. In this manner, a prize for the sub game can be unexpectedly awarded to player.

A fifteenth aspect of the present invention is a gaming machine constituted as set forth below. In the fourteenth aspect, the controller displays the payline on the symbol matrix of the second display device during a period from completion of execution of one less than the predetermined number of main games to display of an outcome of the predetermined number of main games, upon judging in the process (g) that the predetermined number of main games have been executed.

According to the fifteenth aspect of the present invention, the payline is displayed on the symbol matrix of the second display device after main games whose number is one less than a predetermined number has been executed. In this manner, the payline can be displayed on the second display device in a state before symbols are lined up in a winning combination for prize award.

A sixteenth aspect of the present invention is a gaming machine constituted as set forth below. In the fourteenth aspect, the controller: randomly predetermines a given payline from among the plurality of paylines that are settable on the symbol matrix of the second display device; and executes the process (g) so as to display the randomly-predetermined given payline on the symbol matrix of the second display device.

According to the sixteenth aspect of the present invention, one payline is randomly predetermined from among the plurality of paylines that can be set on the symbol matrix of the second display device. In this manner, a player can have expectations for uncertainty.

A seventeenth aspect of the present invention is a gaming machine constituted as set forth below. In the fourteenth aspect, the gaming machine further includes an input device for selecting a given payline from among the plurality of paylines that are settable on the second display device. The controller executes the process (f) based upon a result of the selection of the given payline by the input device, so as to display the selected given payline on the symbol matrix of the second display device.

According to the seventeenth aspect of the present invention, the player selects one payline through the input device. The player can extend his/her strategy for the game, by arbitrarily selecting a payline on the symbol matrix of the second display device.

An eighteenth aspect of the present invention is a gaming machine constituted as set forth below. In the fourteenth aspect, the controller: predetermines a given payline to be set on the first display device; sets the predetermined given payline on the first display device; stores the symbols rearranged on the payline set on the display region on the first display device, every time the main game is executed the predetermined number of times; and executes the sub game in the process (e) in parallel with the main game executed in the processes (b) to (d) on the first display device, the sub game in which the symbol matrix is formed by arranging in the second display device based upon the data stored in the memory, the symbols rearranged on the payline set on the display region on the first display device the main game is executed on the first display device the predetermined number of times.

According to the eighteenth aspect of the present invention, the predetermined payline is randomly set on the first display device. In this manner, the payline can be variously changed on the first display device.

A nineteenth aspect of the present invention is a gaming machine constituted as set forth below. In the fourteenth aspect, the gaming machine further includes an input device for selecting a given payline from among the plurality of paylines that are settable on the first display device. The controller: sets the selected given payline on the display region of the first display device, based upon a result of the selection of the given payline by the input device; stores in the memory the symbols rearranged on the payline set on the display region on the first display device, every time the main game is executed the predetermined number of times; and executes the sub game in the process (e) in parallel with the main game executed in the processes (b) to (d) on the first display device, the sub game in which the symbol matrix is formed by arranging in the second display device based upon the data stored in the memory, the symbols rearranged on the payline set on the display region on the first display device every time the main game is executed on the first display device the predetermined number of times.

According to the nineteenth aspect of the present invention, one payline selected from among the plurality of paylines that can be set on the first display device is set in the display region of the first display device.

According to one aspect of the present invention, a novel gaming machine can be provided which has new entertainability.

### BRIEF DESCRIPTION OF THE DRAWINGS

FIG. 1 is a flowchart showing sub-game processing of a gaming machine according to one embodiment of the present invention;

FIG. 2 is a view showing an overall configuration of the gaming machine according to the embodiment of the present invention;

FIG. 3 is a view showing symbol arrays drawn on peripheral faces of reels of the gaming machine according to the embodiment of the present invention;

FIG. 4 is a block diagram showing an inner configuration of the gamming machine according to the embodiment of the present invention;

FIG. 5 is a view showing a symbol combination table of the gaming machine according to the embodiment of the present invention;

FIG. 6 is a flowchart of main-control processing of the gaming machine according to the embodiment of the present invention;

FIG. 7 is a flowchart of insurance-selection processing of the gaming machine according to the embodiment of the present invention;

FIG. 8 is a flowchart of coin-insertion/start-check processing of the gaming machine according to the embodiment of the present invention;

FIG. 9 is a flowchart of jackpot-related processing of the gaming machine according to the embodiment of the present invention;

FIG. 10 is a flowchart of insurance-related processing of the gaming machine according to the embodiment of the present invention;

FIG. 11 is a flowchart of symbol-determination processing of the gaming machine according to the embodiment of the present invention;

FIG. 12 is identical to FIG. 1 and a flowchart of the sub-game processing of the gaming machine according to the embodiment of the present invention;

FIG. 13A is a view showing an exemplary effect image of the gaming machine according to the embodiment of the present invention;

FIG. 13B is a view showing exemplary symbols displayed in a stopped manner of the gaming machine according to the embodiment of the present invention;

FIG. 14A is a view showing an exemplary effect image of the gaming machine according to the embodiment of the present invention;

FIG. 14B is a view showing exemplary symbols displayed in a stopped manner of the gaming machine according to the embodiment of the present invention;

FIG. 15A is a view showing an exemplary effect image of the gaming machine according to the embodiment of the present invention;

FIG. 15B is a view showing exemplary symbols displayed in a stopped manner of the gaming machine according to the embodiment of the present invention;

FIG. 16 is a flowchart of reel-control processing of the gaming machine according to the embodiment of the present invention;

FIG. 17 is a flowchart of payout-amount-determination processing of the gaming machine according to the embodiment of the present invention;

FIG. 18 is a flowchart of bonus-game processing of the gaming machine according to the embodiment of the present invention;

FIG. 19 is a flowchart of insurance-check processing of the gamming machine according to the embodiment of the present invention;

FIG. 20 is a flowchart of coin-insertion/start-check processing of a gaming machine according to another embodiment of the present invention; and

FIG. 21 is a flowchart of sub-game processing of the gaming machine according to another embodiment of the present invention;

### DESCRIPTION OF THE PREFERRED EMBODIMENTS

Hereinafter, embodiments of the present invention will be described with reference to the drawings. A gaming machine according to the embodiment of the present invention is a slot machine including a lower image display panel 141 (a first display device), an upper image display panel 131 (a second display device), RAM 73, and a main CPU 71. The lower image display panel 141 for use in a main game displays plural types of symbols in a display region every time the main game is executed. The upper image display panel 131 for use in a sub game forms a symbol matrix in association with an arrangement outcome of symbols rearranged in the display region on the lower image display panel 141, every time the main game is executed thereon the predetermined number of times. The upper image display panel 131 also displays paylines in the symbol matrix to show an outcome of the sub game. The RAM 73 stores symbols rearranged in the display region on the lower image display panel 141, every time the main game is executed the predetermined number of times. The RAM 73 also stores a game number as the number of times the main game is executed.

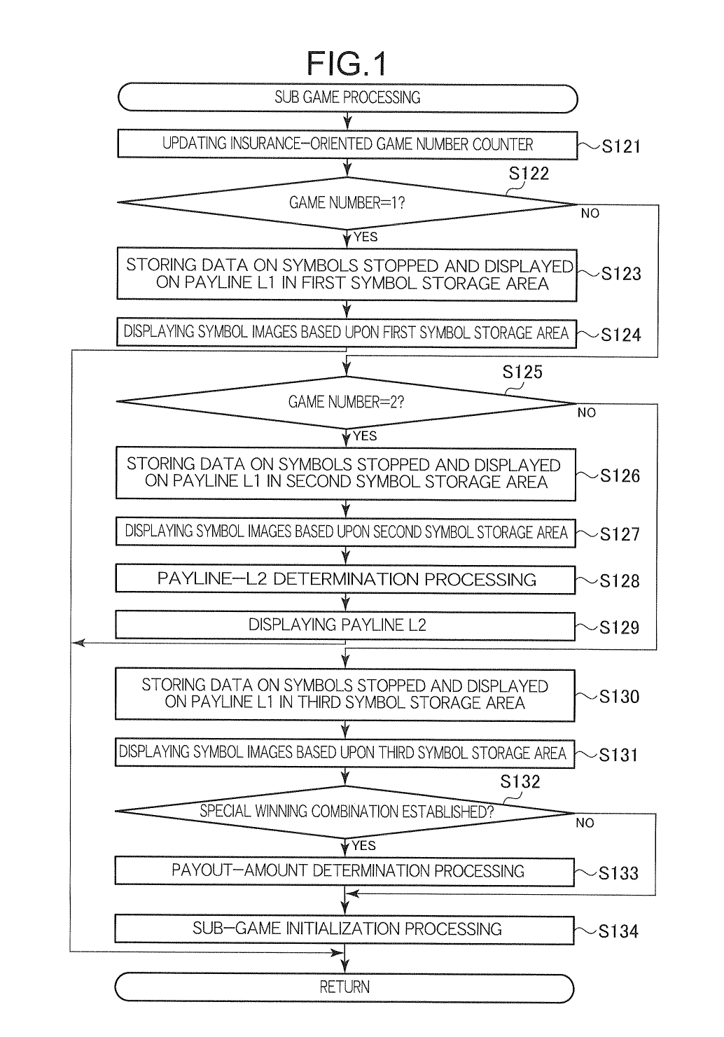

FIG. 1 is a flowchart of sub-game processing. The main CPU 71 is configured to execute processing operations that follow. The main CPU 71 executes the main game in which the plural types of symbols are rearranged in the display region on the lower image display panel 141. The main CPU 71 determines whether or not to award a first prize, in accordance with a displayed outcome of the plural types of symbols rearranged in the display region on the lower image display panel 141. In the case of determining to award the first prize, the main CPU 71 awards the first prize as a prize for the main game and then activates a subsequent main game. In the case of determining not to award the first prize, the main CPU 71 activates a subsequent main game.

The main CPU 71 executes the sub game in parallel with the main game executed on the lower image display panel 141 (S124, S127, and S131). The sub game is executed based on the data stored in the RAM 73 at steps S123, S126, and S130 of FIG. 1, in which the symbol matrix is formed by arranging in the upper image display panel 131, symbols that have been rearranged in the display region on the lower image display panel 141. The sub game is executed every time the main game is executed on the lower image display panel 141 by the predetermined number of times.

The main CPU 71 judges whether or not the predetermined number of main games have been executed, based on the game number data stored in the RAM 73 (S122 and S125).

In the case of judging that the main game has been executed twice, the main CPU 71 displays paylines on the symbol matrix on the upper image display panel 131 (S129). Incidentally, the main CPU 71 may display paylines on the symbol matrix on the upper image display panel 131 during a period from execution of at least one or more main games to execution of the predetermined number (three in this case) of main games.

The main CPU 71 judges whether or not symbols have been arranged in combination for awarding a second prize on any of the paylines of the symbol matrix on the upper image display panel 131 (S132).

In the case of judging that the second prize is awarded, the main CPU 71 awards the second prize as a prize for the sub game (S133).

The main CPU 71 initializes the game number data stored in the RAM 73 (S134).

In the sub game executed on the second display device, the main CPU 71 determines whether or not to award a prize for the sub game, based upon an outcome of symbol rearrangement that is executed on the first display device the predetermined number of times, and upon the paylines set on the second display device. Thus, a novel gaming machine with new entertainability can be provided which executes the main game on the first display device and the sub game on the second display device, in association with an outcome of the predetermined number of main games, based upon different payline-judgment.

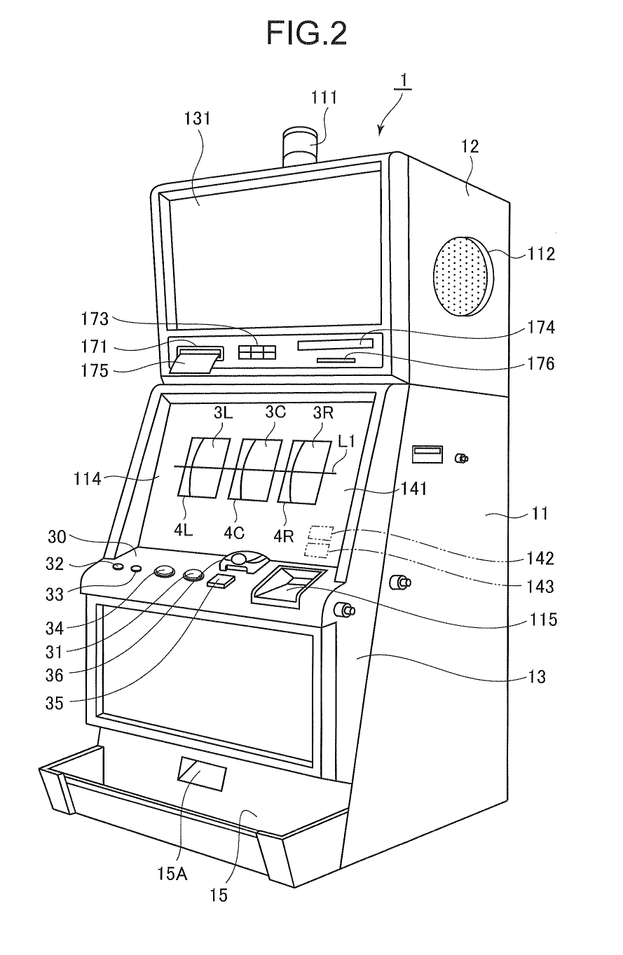

Next, an overall configuration of a gaming machine 1 will be described with reference to FIG. 2.

Gaming media used in the gaming machine 1 include coins, bills, or electronic value information equivalent thereto. Barcode-attached tickets to be described later are also used in this embodiment. The gaming media are not limitative thereto and may employ medals, tokens, electronic money, or the like.

The gaming machine 1 is provided with a cabinet 11, a top box 12 installed on an upper side of the cabinet 11, and a main door 13 provided on a front surface of the cabinet 11. A reel assembly 3 is provided as the first display device inside the cabinet 11. The reel assembly 3 includes three reels 3L, 3C, 3R. Each of the reels 3L, 3C, 3R has a peripheral face with twenty-two symbols drawn thereon. Twenty-two symbols are arranged in a row in a rotation direction of the reel assembly 3 to form a symbol column. The reel assembly 3 (first display device) is employed for the main game, and has a display region in which the plural types of symbols are rearranged every time the main game is executed. In other words, in the main game, the plural types of symbols are displayed in the display region of the reel assembly 3 every time the main game is executed. In the present invention, the first display device is configured to include the reel assembly 3 and the lower image display panel 141.

At the center of the main door 13, the lower image display panel 141 is provided as a front panel covering the reel assembly 3. The lower image panel 141 is provided so as to be positioned at the front side that is superposed on three reels 3L, 3C, 3R, when viewed from the front side.

The lower image display panel 141 serving as the first display device is made up of a transparent liquid crystal panel, and is configured to expose the reels 3L, 3C, 3R behind this panel by forming a display window assembly 4 (windows 4L, 4C, 4L) corresponding to the reel assembly 3 (reels 3L, 3C, 3L). A payline L1 is displayed on the lower image display panel 141.

The lower image display panel 141 displays an image relating to the main game. In the main game, the plurality of reels 3L, 3C, 3R are controlled to rearrange the plural types of symbols displayed thereon, and a prize is awarded in accordance with a displayed outcome of the rearranged symbols.

In the gaming machine according to one aspect of the present invention, the main CPU 73 executes the main game and the sub game in parallel. In the main game, a controller controls the reel assembly 3 to rearrange the plural types of symbols displayed in the display window assembly 4 serving as the display region of the reel assembly 3. A prize is to be awarded in accordance with a winning combination (symbol combination) on the payline L1, for example, from among a combination of rearranged symbols, based upon a displayed outcome of the plural types of rearranged symbols. Upon completion of one main game, the controller executes a subsequent main game after awarding or even not awarding the aforementioned prize.

At the lower image display panel 141, a credit amount display region 142 and a payout amount display region 143 are provided. The credit amount display region 142 displays the number of coins (hereinafter, referred to as the credit amount) that are owned by a player and deposited inside the gaming machine 1. The payout amount display region 143 displays the number of coins (hereinafter, referred to as the payout amount) that are to be paid out to the player when a winning combination is established.

The lower image display panel 141 displays various items of information or an image relating to effect display concerning the game. On the other hand, the display window assembly 4 enables rotating and stopping movement of the reel assembly 3 to be visually recognizable from a side of the player. Each of the display windows 4L, 4C, 4R displays a total of three symbols when rotation of the reels 3L, 3C, 3R is stopped. These three symbols are displayed in upper, middle, and lower columns, respectively, within a frame of each of the display windows 4L, 4C, 4R. One or more lines to be determined inside or selected outside the gaming machine 1 are set to the paylines L1 that indicate whether or not a prize award is established. The payline L1 is set to, for example, a line connecting middle columns of the left reel 3L, the center reel 3C, and the right reel 3R. However, the payline L1 is not limitative thereto.

In a case where symbols that are displayed when rotation of the three reels 3L, 3C, 3R is stopped form a predetermined combination on the payline L1, the payout amount is determined and the corresponding amount of coins is paid out, in accordance with type of the formed combination and the amount of coins (also referred to as the inserted-coin amount or the BET amount) placed on the game of this time.

At the front side of the lower image display panel 141, a touch panel 114 is provided. The player can input various instructions by operating the touch panel 114.

Below the lower image display panel 141, various devices operated by the player, including various buttons provided in a control panel 30, are provided.

The SPIN button 31 is intended to input an instruction of starting rotation of the reel assembly 3. The change button 32 is intended for use in asking an attendant of the gaming facility for change. A CASHOUT button 33 is intended to input an instruction of paying out credited coins to a coin tray 15.

BET buttons (including a 1-BET button 34 and a max-BET button 35) are intended to determine the BET amount based on credited coins. The 1-BET button 34 is intended to input an instruction for setting the aforementioned BET amount to one coin. The max-BET button 35 is intended to input an instruction for setting the aforementioned BET amount to the predetermined upper limit (three coins in this embodiment).

A coin insertion slot 36 is provided to accept coins. A bill validator 115 is provided to accept bills. The bill validator 115 validates whether or not a bill is legitimate and accepts a legitimate bill into a cabinet 11. The bill validator 115 may be configured so that a barcode-attached ticket 175 described later is readable thereby.

At the front surface of the top box 12, there is provided the upper image display panel 131 having a liquid crystal panel, serving as the second display device. The upper image display panel 131 displays images relating to effect display, introduction of game contents, explanation of game rules, and the like. The upper image display panel 131 displays images relating to a sub game that is executed in parallel with the main game.

When the main game is executed the predetermined number of times (three times, for example) using the plurality of reels 3L, 3C, 3R, the main game is executed by forming the symbol matrix (in three column and three rows, for example) on the upper image display panel 131, in association with the symbols rearranged on the payline L1 in each main game. In the sub game, the paylines are displayed in the symbol matrix displayed on the upper image display panel 131 to show an outcome of the sub game that is different from that of the main games.

On the top box 12, a speaker 112 and a lamp 111 are provided. The gaming machine 1 augments the game by displaying effect images or outputting sounds or light, or using a combination thereof.

Below the upper image display panel 131, a ticket printer 171, a card slot 176, a data display unit 174, and a keypad 173 are provided.

The ticket printer 171 prints, on tickets, bar codes containing coded data such as the credit amount, date and time, or an ID number of the gaming machine 1, and outputs the barcode-attached tickets 175. A player can cause the gaming machine to read the barcode-attached tickets 175 to perform games, or alternatively, exchange the barcode-attached tickets 175 with bills or the like at a predetermined site of a game facility (for example, at a casher in a casino).

The card slot 176 is intended to insert thereinto a card storing predetermined data. The card stores, for example, data for identifying a player or data relating to a log of games played by the player.

The card reader 172 to be described later reads/writes data from/into the card inserted in the card slot 176. The card may store data equivalent to coins, bills, or credits.

A data display unit 174 is made up of a fluorescent display, an LED, and the like, and displays the data read by the card reader 172 and the data input by the player via the keypad 173, for example. The keypad 173 is intended to input instructions or data pertinent to the issuance of tickets.

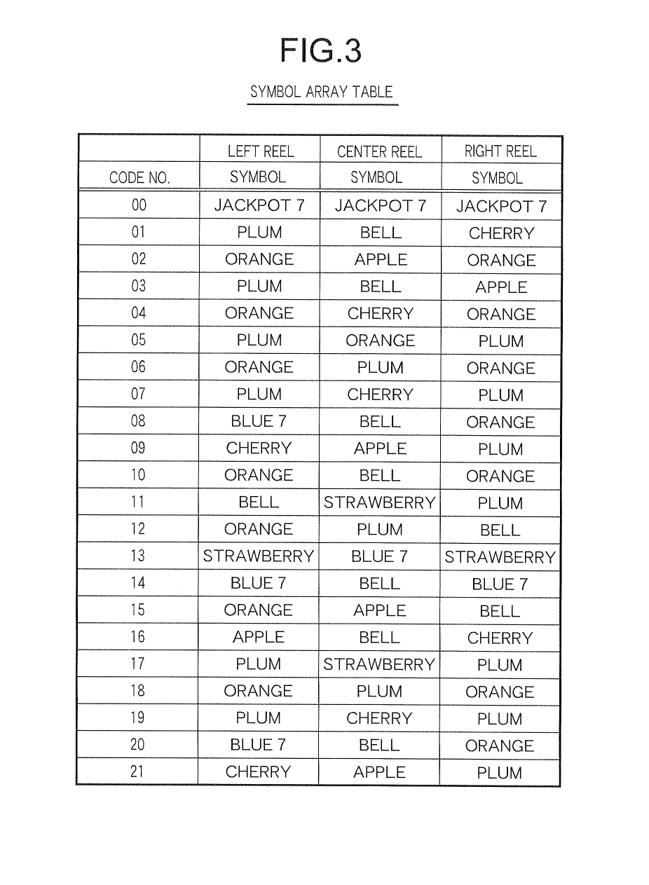

Next, with reference to FIG. 3, a configuration of symbol columns drawn on the peripheral faces of the reels 3L, 3C, 3R of the gaming machine 1 will be described. FIG. 3 is a view showing symbol arrays drawn on peripheral faces of reels of the gaming machine according to the embodiment of the present invention.

A symbol column made up of twenty-two symbols is drawn on the peripheral face of each of the left reel 3L, the center reel 3C, and the right reel 3R.

There are several types of symbols including “JACKPOT 7”, “BLUE 7”, “BELL”, “CHERRY”, “STRAWBERRY”, “PLUM”, “ORANGE”, and “APPLE”.

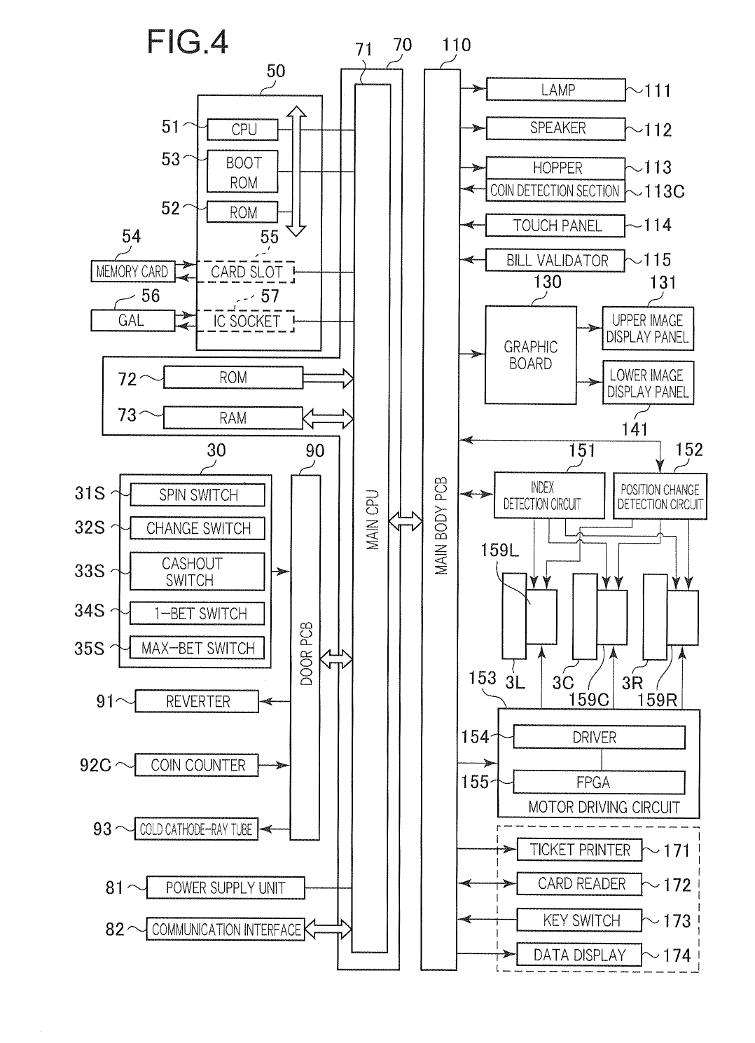

Next, an inner configuration of the gaming machine 1 will be described with reference to FIG. 4. FIG. 4 is a block diagram showing an inner configuration of the gaming machine according to the embodiment of the present invention.

A gaming board 50 is provided with: a CPU 51, a ROM 52, and a boot ROM 53, which were interconnected via an internal bus; a card slot 53 compatible with a memory card 54; and an IC socket 57 compatible with a GAL (Generic Array Logic) 56.

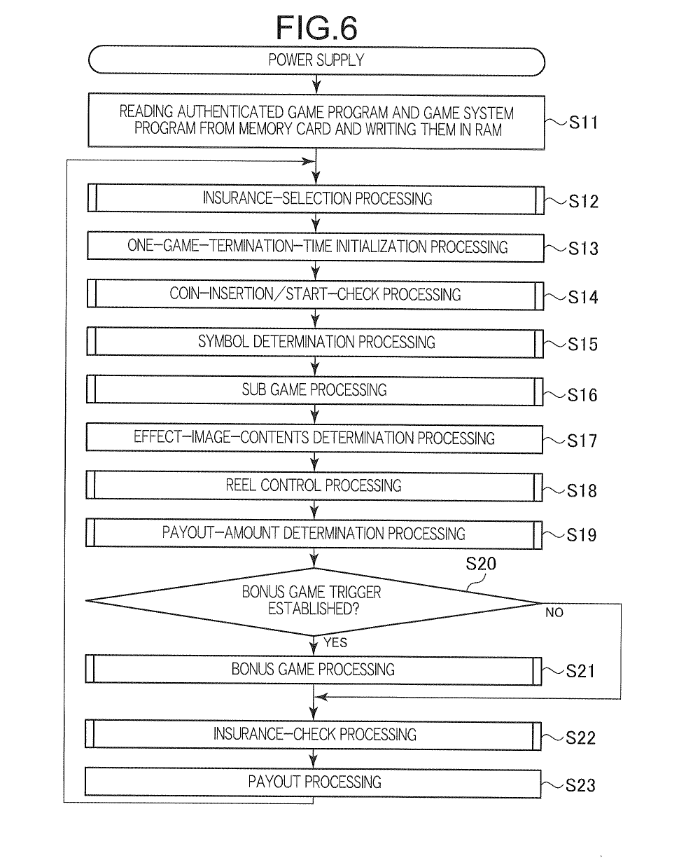

The memory card 54 is made up of a nonvolatile memory, and stores game programs and game system programs. The game programs include a program relating to a game progress, a program for determining a winning combination, and a program for dramatizing a game by means of effect images or sounds (see FIGS. 6 to 12 and FIGS. 16 to 21 to be referred to later). The winning combination determination program is intended to determine symbols (in other words, a code number corresponding to the symbols, as shown in FIG. 3) to be displayed on the payline L1 when the reel assembly 3 is stopped rotating.

The winning combination determination program includes symbol-weighted data corresponding to each of plural types of payout rates (80%, 84%, and 88%, for example). The symbol-weighted data is intended to define random numeric values used for determination of symbols, in accordance with the reels 3L, 3C, 3R.

The card slot 55 is constituted so as to removably insert the memory card 54 thereinto, and is connected to the motherboard 70 by means of an IDE bus.

The GAL 56 is type of PLD (Programmable Logic Device) having an OR-fixed arrayed structure. The GAL 56 is provided with a plurality of IN ports and OUT ports. When the IN port receives predetermined input, the OUT port outputs corresponding data.

The IC socket 57 is constituted so as to removably insert the GAL 56, and is connected to the motherboard 70 by means of a PCI bus. The characteristics or contents of games performed with the gaming machine 1 can be changed by replacing the memory card 54 with that which has another program written therein or rewriting another program into the memory card 54.

The CPU 51, the ROM 52, and the boot ROM 53 that are interconnected by means of an internal bus are connected to the motherboard 70 by means of the PCI bus. The PCI bus not only transmits a signal between the motherboard 70 and the gaming board 50, but also supplies power from the motherboard 70 to the gaming board 50.

The ROM 52 stores an authentication program. The boot ROM 53 stores programs such as a preliminary authentication program and a program (boot code) for the CPU 51 to boot the preliminary authentication program.

The authentication program is a program (falsification check program) for authenticating game programs and game system programs. The preliminary authentication program is intended to authenticate the authentication program described above. The authentication program and the preliminary authentication program are described along the procedures (authentication procedures) for authenticating the fact that targeted game programs are not falsified.

The motherboard 70 includes the main CPU 71 serving as a controller, the ROM 72, the RAM 73 serving as memory, and a communication interface 82.

The ROM 72 is made up of a memory device such as a flash memory, and stores permanent data and a program such as a BIOS to be executed by the main CPU 71. When the main CPU 71 executes the BIOS, processing of initializing predetermined peripheral devices is executed. Further, processing of capturing game programs and game system programs stored in the memory card 54 is started through the gaming board 50.

The RAM 73 stores data or programs employed when the main CPU 71 is activated. For example, upon execution of the processing of capturing the game programs and the game system programs or the authentication programs described above, the RAM 73 can store these programs. In the RAM 73, a work area used to execute the above programs is provided. For example, the RAM 73 has an area that stores a counter for managing, e.g., the number of main games, the BET amount, the payout amount, the credit amount, and the number of bonus games (free games), that are used for the sub game. A payout amount counter is updated in accordance with a winning combination that is determined in the main game as well as the one that is determined in the sub game. The RAM 73 has storage areas for a plurality of items of data concerning symbols (code numbers) determined for each game, the payline L1 set for the main game, a payline L2 set for the sub game, or data concerning symbols for the sub game.

A symbol (code number) storage area stores symbols targeted to be stopped, those having been determined for each game. A payline L1 storage area stores a plurality of items of data concerning the payline L1 set for the main game. Data concerning the payline L1 is used to determine a line payout for the main game. A plurality of items of data concerning the payline L2 set for the sub game are stored in a payline L2 storage area. Data concerning the payline L2 is used to determine a line payout for the sub game. Data concerning the symbols rearranged in the display region of the reel assembly 3 is stored as needed in storage areas for data concerning symbols for the sub game, such as a first symbol storage area, a second symbol storage area, and a third symbol storage area. The above-described data is stored in one of the storage areas, which corresponds to the game number, every time the main game is executed the predetermined number of times. A symbol matrix to be displayed on the upper image display panel 131 is formed based upon the stored data concerning symbols for the sub game.

The communication interface 82 is intended to establish communication with an external control unit 200 such as a server via a communication line 301. Each of a door PCB 90 to be described later and a main body PCB (Printed Circuit Board) 110 is connected to the motherboard 70 by a USB. Further, a power unit 81 is connected to the motherboard 70.

When power is supplied from the power unit 81 to the motherboard 70, the main CPU 71 of the motherboard 70 is activated. Further, power is supplied to the gaming board 50 via the PCI bus, and the CPU 51 is then activated.

Input devices such as a switch and a sensor, or peripheral devices operation of which is controlled by the main CPU 71, are connected to the door PCB 90 and the main PCB 110

The control panel 30, a reverter 91, a coin counter 92C, and a cold cathode-ray tube 93 are connected to the door PCB 70.

Switches are provided on the control panel 30 so as to correspond to the buttons described above, in which the switches include a SPIN switch 31S, a CHANGE switch 32S, a CASHOUT switch 33S, a 1-BET switch 34S, and a max-BET switch 35S. Each of the switches detects a push of the corresponding button by the player, thereby outputting a signal to the main CPU 71.

The coin counter 92C validates legitimacy of coins inserted into the coin insertion slot 36 in terms of material, shape, or the like. The coin counter 92C outputs a signal to the main CPU 71 when detecting a legitimate coin. Further, those other than the legitimate coins are discharged from a coin payout exit 15A.

The reverter 91 operates based upon a control signal output from the main CPU 71 and distributes the legitimate coins validated by the coin counter 92C, into a hopper 113 or a cashbox (not shown). The legitimate coins are distributed into the hopper 113 when the hopper 113 is not filled with coins. When the hopper 113 is filled with coins, the legitimate coins are distributed into the cash box.

The cold cathode-ray tube 93 functions as a backlight installed at the rear side of the lower and upper image display panels 141 and 131. This backlight illuminates based upon the control signal output from the main CPU 71.

To the main body PCB 110, a lamp 111, a speaker 112, the hopper 113, a coin detection section 113S, the touch panel 114, a bill validator 115, a graphic board 130, an index detection circuit 151, a position change detection circuit 152, a motor driving circuit 153, a ticket printer 171, a card reader 172, a key switch 173S, and a data display 174 are connected.

The lamp 111 lights based upon a control signal output from the main CPU 71. The speaker 112 outputs a sound such as BGM based upon a control signal output from the main CPU 71.

The hopper 113 operates based upon a control signal output from the main CPU 71, and pays out the designated payout amount of coins from the coin payout exit 15A to the coin tray 15. The coin detection 113 S detects a coin paid out by the hopper 113, thereby outputting a signal to the main CPU 71.

The touch panel 114 detects a position where the player toughed with his/her finger, for example, and outputs to the main CPU 71, a position signal corresponding to the detected position. Upon accepting a legitimate bill, the bill validator 115 outputs to the main CPU 71 a signal corresponding to the bill amount.

A graphic board 130 controls images to be displayed by each of the upper image display panel 131 and the lower image display panel 141, based upon the control signal output from the main CPU 71. The graphic board 130 is provided with a VDP for generating image data, a video RAM for storing the image data generated by the VDP, and the like.

The motor driving circuit 153 is provided with an FPGA (Field Programmable Gate Array) 155 and a driver 154. A stepping motor assembly 159 (stepping motors 159L, 159C, 159R) for rotating the reel assembly 3 is connected to the motor driving circuit 153.

The FPGA 155 is an electronic circuit such as a programmable LSI, and functions as a control circuit of the stepping motor assembly 159. The driver 154 functions as a circuit for amplifying pulses input to the stepping motor assembly 159.

The index detection circuit 151 detects a position of the reel assembly 3 in a rotating state, and further, is capable of detecting step-out of the reel assembly 3.

The position change detection circuit 152 detects a change in a stop position of the reels assembly 3 after the reel assembly 3 has stopped rotating. For example, the position change detection circuit 152 detects change in stop position of the reel assembly 3 in a case where, even if the reel assembly 3 is actually stopped at the position at which a winning combination for awarding a prize is not formed, the player forcibly changes the stop position so as to form the winning combination for awarding a prize by illegitimate external action. The position change detection circuit 152 is constituted so that the change of the stop position of the reel assembly 3 can be detected by detecting a fin (not shown) mounted to the inside of the reel assembly 3 at predetermined intervals.

An excitation system of the stepping motor assembly 159 is not limitative in particular, so that the stepping motor assembly 159 can employ a 1-2-phase excitation system or a 2-phase system. A DC motor may be employed in place of the stepping motor. In a case where the DC motor is employed, a deviation counter, a D/A converter, and a servo amplifier are connected to the main body PCB 110 in sequential order, and the DC motor is connected to the servo amplifier. Further, the rotational position of the DC motor is detected by means of a rotary encoder, and data concerning the current rotational position of the DC motor is supplied from the rotary encoder to the deviation counter.

The ticket printer 171 prints, on tickets, bar codes containing the coded data concerning the credit amount, date and time, and ID number of the gaming machine 1, for example, that are stored in the RAM 73, based upon the control signal output from the main CPU 71. The ticket printer 171 then outputs the tickets as the barcode-attached tickets 175.

The card reader 172 reads out data stored in a card having been inserted into the card slot 176, thereby transmitting the data to the main CPU 71, or writes data into the card based upon a control signal from the main CPU 71.

The key switch 173S is provided on the key pad 173, and outputs a predetermined signal to the main CPU 71 when a player operates the key pad 173.

Based upon a control signal output from the main CPU 71, the data display 174 displays the data read by the card reader 172 or the data input by the player through the key pad 173.

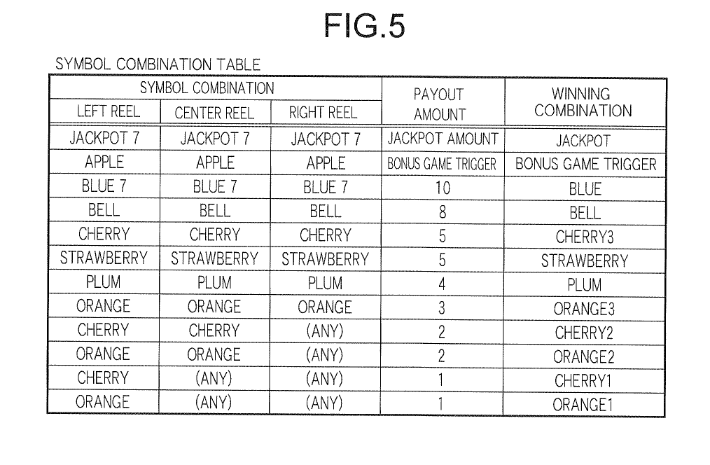

Next, a symbol combination table will be described with reference to FIG. 5. FIG. 5 is a view showing a symbol combination table of the gaming machine according to the embodiment of the present invention.

The symbol combination table defines a winning combination (a combination of symbol patterns) for awarding a prize, and a payout amount. The gaming machine 1 judges that awarding a prize corresponding to a winning combination is established, in a case where the symbols displayed on the payline L1 when rotation of the reel assembly 3 is stopped form a winning combination defined in the symbol combination table. In accordance with the winning combination, the gaming machine 1 offers the player a benefit such as coin payout or start of the bonus game. In a case where the symbols displayed on the payline does not form any of symbol combinations defined in the symbol combination table, it is judged to be so-called “losing”.

Basically, a winning combination is established in a case where three symbols of the identical pattern type from among “JACKPOT 7”, “APPLE”, “BLUE 7”, “BELL”, “CHERRY”, “STRAWBERRY”, “PLUM”, and “ORANGE” are displayed on the payline L1 across the three reels 3L, 3C, 3R. A winning combination is also established in a case where one or two symbols of either of the identical pattern types “CHERRY” and “ORANGE” are displayed on the payline L1 across the three reels 3L, 3C, 3R.

For example, in a case where three symbols of the pattern type “BLUE 7” are displayed on the payline L1 across the three reels 3L, 3C, 3R, a winning combination of “BLUE” is established and the payout amount is determined to be “10”. Coins are paid out based upon the determined payout amount. Coins are paid out by actually discharging coins from the coin payout exit 15A, adding the payout amount to the credit amount, or issuing the barcode-attached ticket.

A “JACKPOT 7” symbol is a trigger for the jackpot. In a case where three same “JACKPOT 7” symbols are displayed on the payline L1 across the three reels 3L, 3C, 3R, a winning combination of “JACKPOT” is established, and the jackpot amount is determined to be the payout amount.

An “APPLE” symbol is a trigger for the bonus game. In a case where three same “APPLE” symbols are displayed on the payline L1 across the three reels 3L, 3C, 3R, a winning combination of “BONUS GAME” is established, and the bonus game is started from the next play of the game.

Next, the program executed by the gaming machine 1 will be described with reference to FIGS. 6 to 12 and 16 to 19. FIGS. 6 to 12 and 16 to 19 are views showing a flowchart of the gaming machine according to the embodiment of the present invention.

First, main processing will be explained. FIG. 6 is a flowchart showing a routine of the main processing of the gaming machine 1. First, when power is supplied to the gaming machine 1, the main CPU 71 reads the authenticated game program and game system program from the memory card 54 through the gaming board 50 and writes the programs in the RAM 73 at step 11 (hereinafter, the word “Step” is simply referred to as “5”).

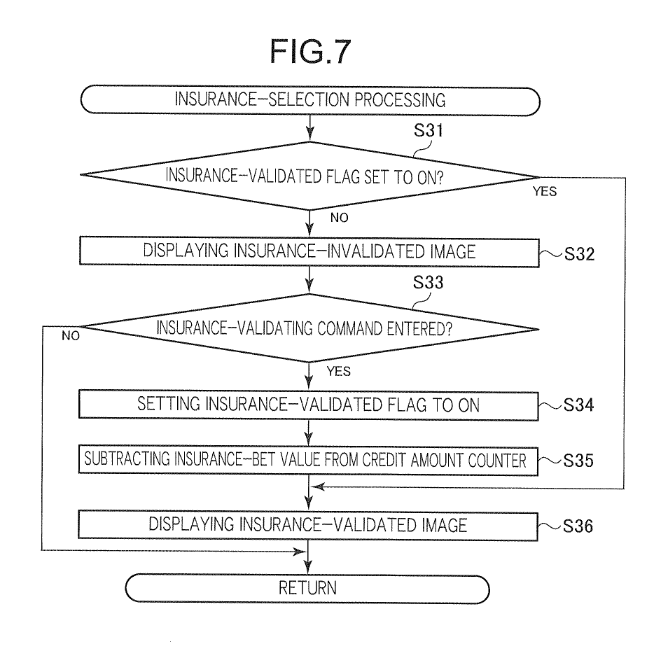

Next, the main CPU 71 performs insurance-selection processing (S12). This processing allows the player to select whether to validate insurance. The insurance-selection processing will be explained later in detail with reference to FIG. 7.

The main CPU 71 then performs initialization processing when one game terminates (S13). For example, the main CPU 71 clears data concerning the BET amount or the determined symbols, for example, which needs to be erased from the work area of the RAM 73 upon completion of every single game. Specifically, the main CPU (controller) sets the next main game in an executable condition by clearing data needed to be erased, in each of the cases of awarding and failing to award a prize for the main game.

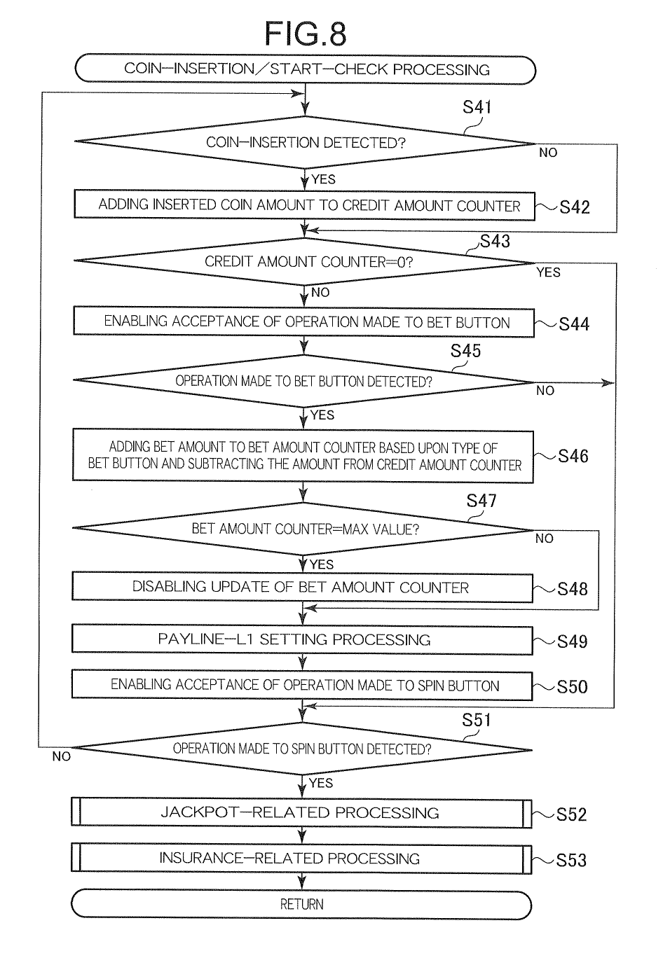

The main CPU 71 then performs coin-insertion/start-check processing (S14). In this processing, for example, the main CPU 71 checks an input through the BET switch or the SPIN switch. The coin-insertion/start-check processing will be explained later in detail with reference to FIG. 8.

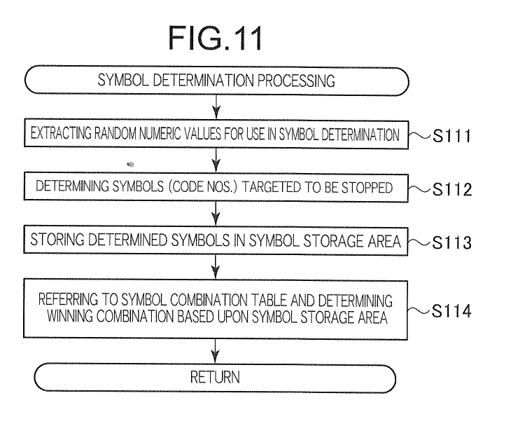

Next, the main CPU 71 performs symbol-determination processing (S15). In this processing, the main CPU 71 determines, based upon random numeric values for use in symbol determination, symbols (code numbers) that are rearranged in a stopped state when reel rotation is stopped. The symbol-determination processing will be explained later in detail with reference to FIG. 11.

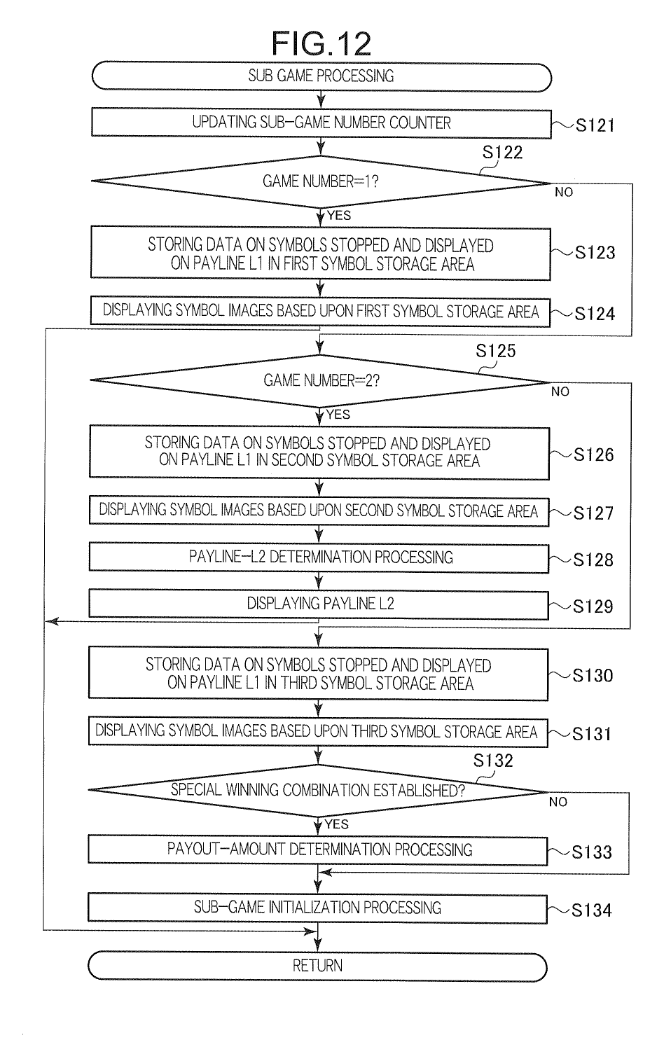

The main CPU 71 then performs sub-game processing (S16). In this processing, the main CPU 71 stores symbols having been targeted to be stopped, and performs the sub game in accordance with the displayed symbols and the preset payline. The sub-game processing will be explained later in detail with reference to FIG. 12.

The main CPU 71 performs processing of determining contents of effect images (S17). In this processing, the main CPU 71 determines the contents of effect images based upon random numeric values for use in creating effect images, with reference to symbols targeted to be stopped, those having been determined in the symbol-determination processing at S14.

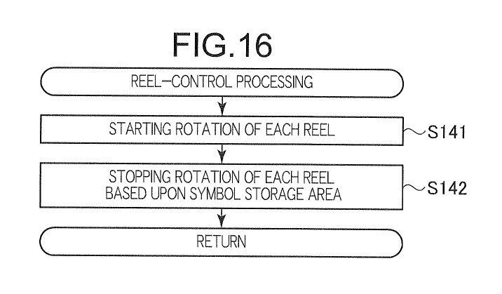

The main CPU 71 then performs reel-control processing (S18). In this processing, the main CPU 71 controls the reel assembly 3 to stop rotation thereof so as to display on the payline L1 the symbols targeted to be stopped, those having been determined in the symbol-determination processing at S15. The reel-control processing will be explained in detail with reference to FIG. 16.

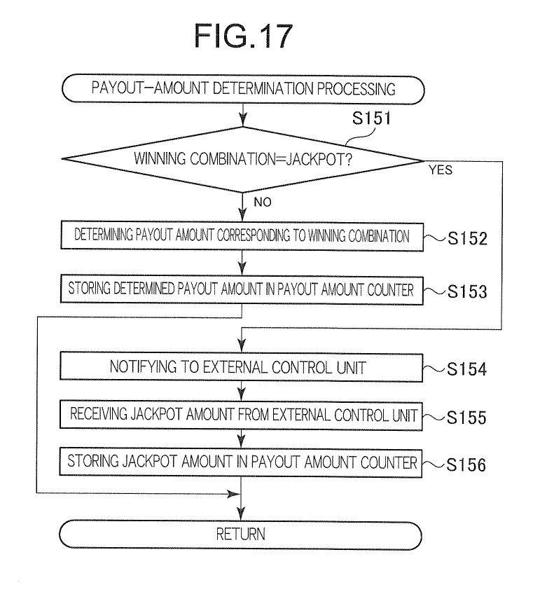

Next, the main CPU 71 then performs payout-amount-determination processing (S19). In this processing, the main CPU 71 determines a payout amount based upon a combination of the symbols displayed on the payline L1, and stores the amount in a payout amount counter set in the RAM 73. The payout-amount-determination processing will be explained later in detail with reference to FIG. 17.

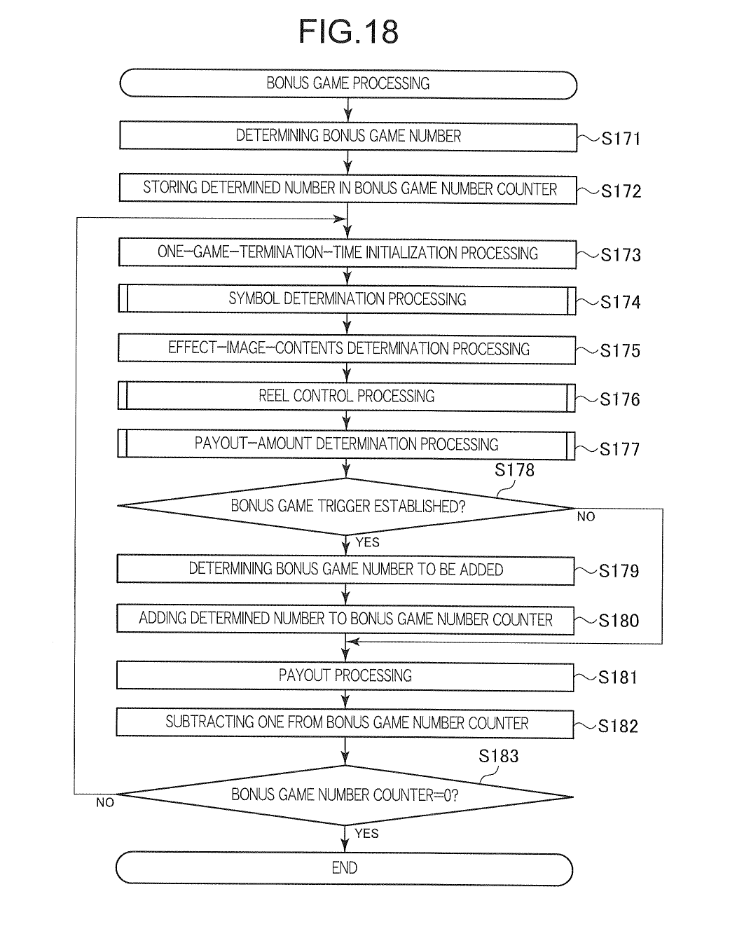

The main CPU 71 then judges whether or not a trigger for the bonus game has been established (S20). The main CPU 71 performs bonus-game processing upon judging that the bonus game trigger has been established (S21). In this processing, the main CPU 71 reads out a program relating to the bonus-game processing, which will be explained later in detail with reference to FIG. 18, and then starts the bonus game from the next play of the game by executing this program.

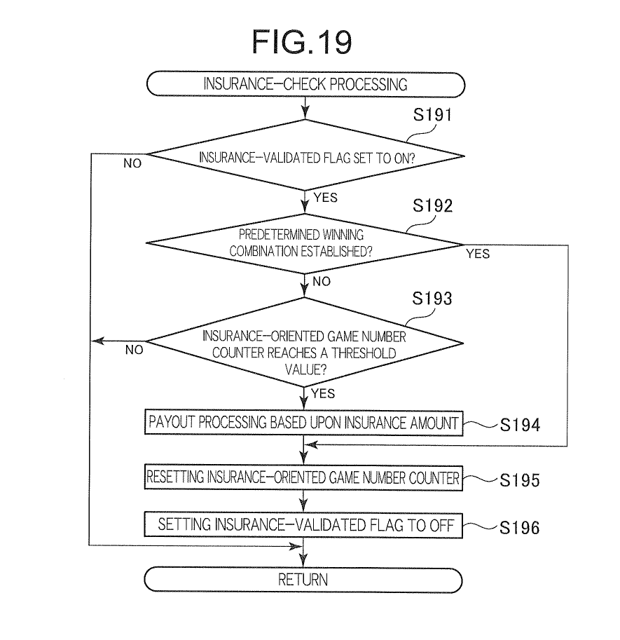

The main CPU 71 then performs insurance-check processing (S22). The main CPU 71 performs the insurance-check processing after the processing at S21 has been completed or upon judging at S20 that the bonus game trigger has not been established. In this processing, the main CPU 71 checks whether the game number for insurance purpose reaches a threshold value in a case where an insurance-validated flag is set to ON at S191 of FIG. 19 to be explained later. The main CPU 71 performs payout based upon insurance when the game number for the purpose of insurance reaches a threshold value. The insurance-check processing will be explained later with reference to FIG. 19.

Next, the main CPU 71 performs payout processing (S23). In this processing, the main CPU 71 basically adds a value stored in the payout amount counter to a value of the credit amount counter set in the RAM 73. The payout amount counter is updated upon establishment of a winning combination for awarding a prize in the main game or the sub game. In this processing, coins may be discharged from the coin payout exit 15A by controlling driving of the hopper 113 based upon input through the CASHOUT switch 33S. Further, the barcode-attached ticket may be issued by controlling driving of the ticket printer 171. After this processing, the CPU 71 reverts to S12.

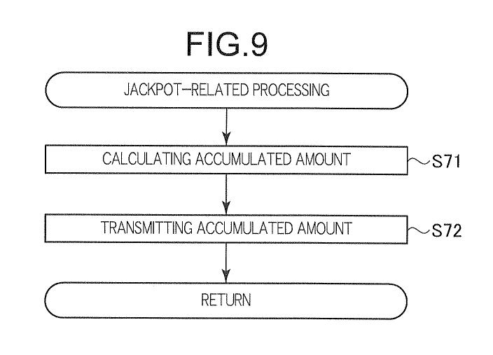

Next, insurance-selection processing will be explained. FIG. 9 is a flowchart showing a subroutine of the insurance-selection processing. First, the main CPU 71 judges whether or not the insurance-validated flag is set to ON (S31). The main CPU 71 displays an insurance-invalidated image upon judging that the insurance-validated flag is not set to ON (S32). After that, the main CPU 71 transmits to the graphic board 130 a command for displaying the insurance-invalidated image. The graphic board 130 generates the insurance-invalidated image based upon this command, thereby displaying the image on the lower image display panel 141.

For example, an image indicative of “INSURANCE BET $1.00 TOUCH TO BET” is displayed as the insurance-invalidated image. This image is to prompt the player to select whether to validate insurance as well as to notify the player of the amount required to validate insurance. The player can enter a command to validate insurance by touching a predetermined spot on the touch panel 114.

The main CPU 71 subsequently judges whether or not an insurance-validating command has been entered (S33). The main CPU 71 leaves the insurance valid flag set to OFF and terminates the insurance-selection processing upon judging that the insurance-validating command has not been entered. On the other hand, the main CPU 71 sets the insurance valid flag to ON when judging that the insurance-validating command has been entered (S34).

Next, the main CPU 71 subtracts an insurance-bet value from the current value of the credit amount counter (S35). In this embodiment, a value corresponding to one dollar, for example, is subtracted from the current value of the credit amount counter. The main CPU 71 displays the insurance-validated image (S36). Specifically, the main CPU 71 displays the insurance-validated image after the processing at S35 has been completed or upon judging at step S31 that the insurance-validated flag is set to ON.

For example, an image indicative of “INSURANCE-PROCESSING WIN 200 CREDIT” is displayed as the insurance-invalidated image. This image is intended to notify the player that the insurance is valid and that a value of “200” is added to the value of the credit amount counter when a condition for the insurance is met. After the completion of this processing, the main CPU 71 terminates the insurance-selection processing.

Next, the coin-insertion/start-check processing will be explained. FIG. 8 is a flowchart showing a subroutine of the coin-insertion/start-check processing. First, the main CPU 71 judges whether or not the coin counter 92C detects insertion of coins (S41). Upon judging insertion of coins, the main CPU 71 adds the amount of coins to the value of the credit amount counter (S42). The main CPU 71 may be configured to judge whether or not the bill validator 115 detects insertion of bills as well as the insertion of coins. In this case, the main CPU 71 adds a value corresponding to the amount of bills to the value of the credit amount counter when judging that insertion of bills has been detected.

Next, the main CPU 71 judges whether or not the value of the credit amount counter is equal to zero (S43). Specifically, the main CPU 71 judges whether or not the value of the credit amount counter is equal to zero, after the processing at S42 has been completed or when judging at S41 that insertion of coins has not been detected (S43). The main CPU 71 enables acceptance of an operation input through the BET button when judging that the value of the credit amount counter is not equal to zero (S44).

The main CPU 71 then judges whether or not the operation input through the BET button has been detected by means of the BET switch (S45). The main CPU 71 subtracts the BET amount from the value of the credit amount counter (S46). Specifically, upon judging that operation input through the BET button has been detected by means of the BET switch, the main CPU 71 adds the BET amount to the value of the BET amount counter set in the RAM 73 and subtracts the BET amount from the value of the credit amount counter, based upon type of the BET button.

Next, the main CPU 71 judges whether or not the BET amount counter stores the maximum value (S47). Upon judging that the BET amount counter stores the maximum value, the main CPU 71 disables update of the BET amount counter (S48).

The main CPU 71 then performs payline-L1-setting processing (S49). Specifically, the main CPU 71 performs the payline-L1-setting processing after the processing at S48 has been completed or when judging at S47 that the BET amount counter fails to store the maximum value. The main CPU 71 sets the payline L1 in any position of the display window assembly 4 while the payline L1 is displayed in the display window assembly 4 of the display region so as to cross over the reels 3L, 3C, 3R. The main CPU 71 then stores the set payline L1 in the RAM 73. The main CPU 71 may set the payline L1 randomly at any position. The main CPU 71 exercises control so as to set the payline L1 at any position, every time the main game is executed. The main CPU 71 may be configured to set the payline L1 in any position every time the sub game is completed, that is, when the game number for the sub game is cleared to zero. The main CPU 71 displays the preset payline L1 in the display region on the lower image display panel 141.

The main CPU 71 then enables acceptance of an operation input through the SPIN button (S50). Specifically, the main CPU 71 enables acceptance of the operation input through the SPIN button after the processing at S49 has been completed.

Next, the main CPU 71 judges whether or not an operation input through the SPIN button 31 has been detected (S51). Specifically, the main CPU 71 judges following the processing at S50, the main CPU 71 judges whether or not the operation input through the SPIN button has been detected when judging at S45 that the operation input through the BET button has not been detected, or when judging at S43 that the credit amount counter stores zero. Next, the main CPU 71 reverts to S41 upon judging that the operation input through the SPIN button has not been detected.

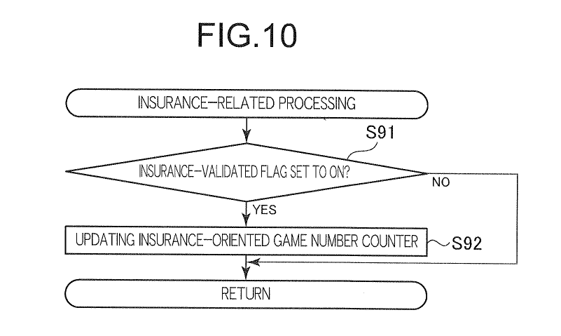

The main CPU 71 performs jackpot-related processing upon judging that the operation input through the SPIN button has been detected (S52). The jackpot-related processing will be described later in detail with reference to FIG. 9. Next, the main CPU 71 performs insurance-related processing (S53). The insurance-related processing will be described later with reference to FIG. 10. Upon execution of this processing, the main CPU 71 terminates the coin-insertion/start-check processing.

Next, the jackpot-related processing will be explained. FIG. 9 is a flowchart showing a subroutine of the jackpot-related processing. First, the main CPU 71 calculates the accumulated amount (S71). The main CPU 71 calculates the jackpot accumulated amount by determining a product of a value in the BET amount counter and a predetermined accumulation ratio.

The main CPU 71 transmits to the external control unit 200 the accumulated amount calculated in the above-described manner (S72). The external control unit 200 updates the jackpot amount upon receipt of the accumulated amount. Upon execution of this processing, the main CPU 71 terminates the jackpot-related processing.

Next, the insurance-related processing will be explained. FIG. 10 is a flowchart showing a subroutine of the insurance-related processing. The main CPU 71 judges whether or not the insurance-validated flag is set to ON (S91). In the insurance-selection processing shown in FIG. 7, the insurance-validated flag is set to ON upon detection of an operation input by the player through the touch panel 114.

Upon judging that the insurance-validated flag is not set to ON, the main CPU 71 terminates the insurance-related processing. On the other hand, upon judging that the insurance-validated flag is set to ON, the main CPU 71 updates a game number counter for the purpose of insurance set in RAM 73 (S92). The insurance-purpose game number counter is intended to control the number of games having been executed from when the insurance-validated flag is set to ON, in which one is added to the value of the counter in this processing. Upon execution of this processing, the main CPU 71 terminates the insurance-related processing.

Next, a subroutine of symbol-determination processing will be explained. FIG. 11 is a flowchart showing a subroutine of the symbol-determination processing. First, the main CPU 71 extracts random numeric values for use in determination of symbols (S111). Next, the main CPU 71 determines symbols (code numbers) that are to be stopped on the reels 3L, 3C, 3R (S112). The main CPU 71 extracts random numeric values in accordance with each of the reels 3L, 3C, 3R and determines any of twenty-two symbols of the plural types set for each of the reels 3L, 3C, 3R. In the reel-control processing to be described later, the main CPU 71 controls the reels 3L, 3C, 3R, to rearrange and display the symbols targeted to be stopped, those having been determined at S112 in the display windows 4L, 4C, 4R as the display region of the lower image display panel 141.

The main CPU 71 stores the symbols targeted to be stopped, those having been determined for each reel in the symbol storage area set in the RAM 73 (S113). The main CPU 71 then determines a winning combination based upon the symbol storage areas with reference to the symbol combination table (FIG. 5) (S114). Specifically, the main CPU 71 determines whether to establish a winning combination for awarding a prize in accordance with a displayed result of the symbols of the plural types that are determined at S112 and rearranged in the reel-control processing to be described later. Upon execution of this processing, the main CPU 71 terminates the symbol-determination processing.

For example, in a case where the symbol on the left reel 3L is “APPLE” corresponding to the code number of “16”; the symbol on the center reel 3C is “APPLE” corresponding to the code number “15”; and the symbol on the right reel 3R is “APPLE” corresponding to the code number of “03”, a winning combination is determined to be a “bonus game trigger” (see FIGS. 3 and 5).

Next, sub-game processing will be explained. FIG. 12 is a flowchart showing a subroutine of sub-game processing. This example describes a case in which a predetermined number according to the present invention is set to three. First, the main CPU 71 updates a game number counter for the sub game (S121). Specifically, the main CPU 71 updates the game number counter for the sub game by reading out the game number from a storage area of the game number counter for the sub game stored in the RAM 73, adding one to the game number, and storing the sum in the storage area.

The main CPU 71 then judges whether the game-number is equal to one or not (S122). That is, the main CPU 71 reads out the game number of the game number counter for the sub game from the storage area of the RAM 73, and judges whether or not the game number readout is equal to one. Upon judging that the game number readout is equal to one, the main CPU 71 proceeds to S123. Upon judging that the game number readout is not equal to one, the main CPU 71 proceeds to S125.

The main CPU 71 performs processing of storing the symbol data in the first symbol storage area (S123). Specifically, the main CPU 71 stores data concerning the symbols having been stopped on the payline L1 in the first symbol storage area for the sub game included in the RAM 73.

Next, the main CPU 71 displays symbol images based upon the first symbol storage area (S124). Specifically, the main CPU 71 displays symbols based upon the symbol data stored in the first symbol storage area of the RAM 73, on the lower column of the symbol matrix of the upper image display panel 131.

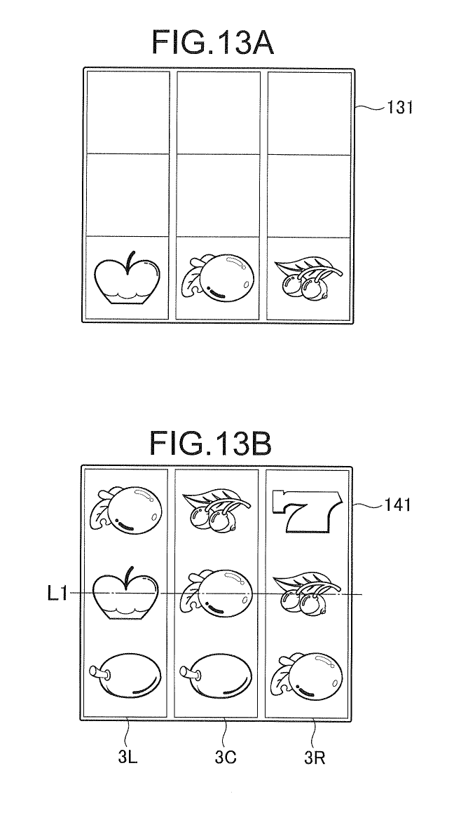

Herein, an effect image displayed at S124 will be explained with reference to the drawings. FIG. 13A is a view showing an exemplary effect image displayed when rotation of the reels is stopped. FIG. 13B is a view showing exemplary symbols targeted to be stopped in the gaming machine according to the embodiment of the present invention.

In this example, the lower column of the upper image display panel 131 displays a symbol combination identical to that which is displayed on the payline L1 when rotation of the reel assembly 3 is stopped.

In this example, the “APPLE” symbol is displayed on the payline L1 of the reel 3L. The “ORANGE” symbol is displayed on the payline L1 of the reel 3C. The “CHERRY” symbol is displayed on the payline L1 of the reel 3R. The same symbols as “APPLE”, “ORANGE” and “CHERRY” symbols displayed on the payline L1 are displayed in the lower column of the symbol matrix of the upper image display panel 131, as shown in FIG. 13A. Turning now to FIG. 12, an explanation of the sub-game processing will be continued.

The main CPU 71 then judges whether or not the game number is equal to two (S125). Specifically, if the main CPU 71 does not judge at S122 that the game number readout is equal to one, it reads out the game number of the game number counter for the sub game from the storage area of the RAM 73, thereby judging whether or not the game number readout is equal to two. Upon judging that the game number readout is equal to one, the main CPU 71 proceeds to S126. Upon failure to judge that the game number readout is equal to two, the main CPU 71 proceeds to S130.

Next, the main CPU 71 performs processing of storing the symbol data in the second symbol storage area (S126). Specifically, the main CPU 71 stores data concerning the symbols having been stopped on the payline L1 in the second symbol storage area for the sub game included in the RAM 73.

The main CPU 71 then displays symbol images based upon the second symbol storage area (S127). Specifically, the main CPU 71 displays symbols based upon the symbol data stored in the second symbol storage area of the RAM 73, on the middle column of the symbol matrix of the upper image display panel 131.

Next, the main CPU 71 performs processing of determining the payline L2 (S128). Specifically, the main CPU 71 displays the payline L2 on the symbol matrix of the upper image display panel 131 during a period from execution of the main game at least one or more times (two times in this case) to execution thereof the predetermined number of times. The main CPU 71 displays the payline L2 on the symbol matrix of the upper image display panel 131 during a period from the completion of execution of main games whose number is one less than the predetermined number (three in this case) (i.e., from completion of execution of two main games) to display of an outcome of the main game executed the predetermined number of times (three times in this case). Specifically, the main CPU 71 randomly predetermines one from among the plurality of paylines L2 that are can be set on the symbol matrix of the upper image display panel 131, and performs processing so as to display the predetermined payline L2 on the symbol matrix of the upper image display panel 131. The main CPU 71 then stores data concerning the determined payline L2 in the RAM 73, for example.

The main CPU 71 then performs processing of displaying the payline L2 (S129). The main CPU 71 then displays the payline L2 determined at S128, so as to be superimposed on the symbol matrix of the upper image display panel 131.

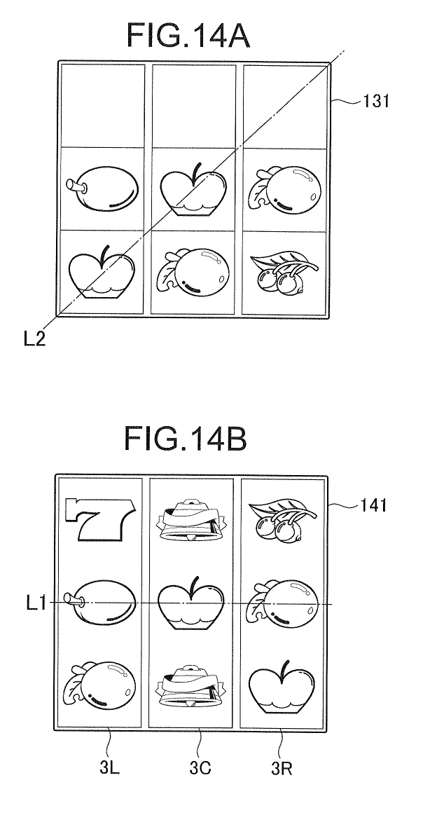

Hereinafter, an effect image displayed at S127 and S129 will be explained with reference to the drawings. FIG. 14A is a view showing an exemplary effect image when rotation of the reels is stopped. FIG. 14B is a view showing exemplary symbols displayed in a stopped state in the gaming machine according to the embodiment of the present invention.

Like the processing at S124, the middle column of the upper display panel displays a symbol combination identical to that which is displayed on the payline L1 when rotation of the reel assembly 3 is stopped.

As shown in FIG. 14B, the “PLUM” symbol is displayed on the payline L1 of the reel 3L. The “APPLE” symbol is displayed on the payline L1 of the reel 3C. The “ORANGE” symbol is displayed on the payline L1 of the reel 3R. After the processing at S127 has been executed, the same symbols as “PLUM”, “APPLE”, and “ORANGE” symbols displayed on the payline L1 are displayed in the middle column of the symbol matrix on the upper image display panel 131, as shown in FIG. 14A. After the processing at S129 has been executed, the determined payline L2 for the sub game is displayed. The gaming machine can inform the player as to which payline L2 is used for prize award of the sub game by displaying the payline L2. Turning to FIG. 12, the sub-game processing is continuously explained.

The main CPU 71 then performs processing of storing symbol data in the third symbol storage area (S130). In other words, in a case of failure to judge at S125 that the game number is equal to two, the main CPU 71 determines that the game number is equal to three, and then, stores data concerning the symbols stopped on the payline L1 in the third symbol storage area for the sub game included in the RAM 73.

The main CPU 71 then displays symbol images with reference to the third symbol storage area (S131). Specifically, the main CPU 71 displays symbols based upon the symbol data stored in the third symbol storage area of the RAM 73, in the upper column of the symbol matrix of the upper image display panel 131. Specifically, the main CPU 71 forms the symbol matrix by arranging the symbols on the upper image display panel 131, the symbols having been rearranged in the display region of the reel assembly 3 every time the main game is executed. The main CPU 71 performs the sub game with use of the formed symbol matrix and a position of the displayed payline L2.

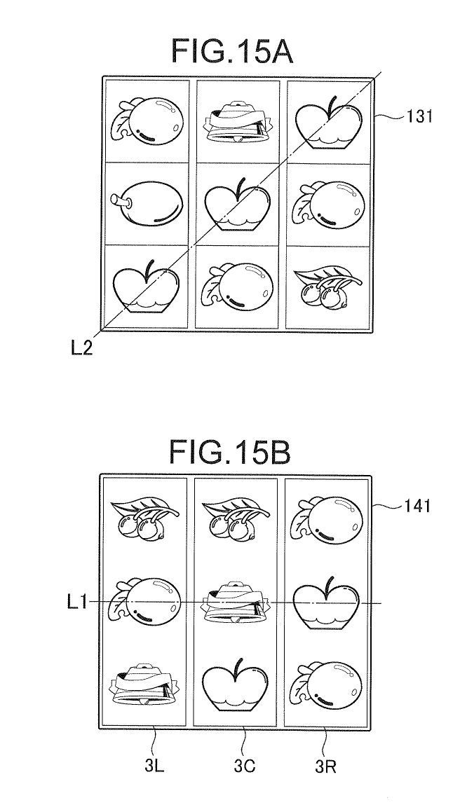

Herein, an effect image displayed at S131 will be explained with reference to the drawings. FIG. 15A is a view showing an exemplary effect image when rotation of the reels is stopped. FIG. 15B is a view showing exemplary symbols stopped and displayed in the gaming machine according to the embodiment of the present invention.

In the same manner as that of S124, the upper column of the upper display panel displays a symbol combination identical to that which is displayed on the payline L1 when rotation of the reel assembly 3 is stopped during a further next game.

As shown in FIG. 15B, the “ORANGE” symbol is displayed on the payline L1 of the reel 3L. The “BELL” symbol is displayed on the payline L1 of the reel 3C. The “APPLE” symbol is displayed on the payline L1 of the reel 3R. As shown in FIG. 15A, the same symbols as the “ORANGE”, “BELL”, and “APPLE” symbols displayed on the payline L1 are displayed in the upper column of the symbol matrix of the upper image display panel 131. Further, the payline L2 for the sub game is displayed. Turning to FIG. 12, the sub-game processing is continuously explained.

Next, the main CPU 71 judges whether or not a winning combination for awarding a prize is established (S132). The main CPU (controller) judges based upon the game number data stored in the RAM 73, whether or not the permissible main game has been executed the predetermined number of times. Specifically, the main CPU 71 judges at S122 and S125 that the game number is not one or two but the predetermined number (three in this case). The main CPU 71 subsequently executes the sub game in which the symbol matrix is formed by arranging symbols on the upper image display panel 131, the symbols having been rearranged in the display region of the reel assembly, every time the main game is executed. Specifically, the main CPU 71 refers to the symbol combination table stored in the RAM 73 to judge whether or not a winning combination is established, the winning combination being determined based upon the symbol data stored in the first, second, and third symbol storage areas for the sub game in the RAM 73 and positions of the symbols on the payline L2 of the sub game. In other words, the main CPU judges (determines) whether or not a winning combination relating to the sub game is arranged on the payline on the symbol matrix of the upper image display panel 131.

Upon judging that award of a wining combination relating to the sub game exists, the main CPU 71 proceeds to S133. Upon failure to judge that award of a winning combination relating to the sub game exists, the main CPU 71 proceeds to S134.

In the example case shown in FIG. 15A, for example, the symbol matrix is generated, in which the payline L2 is displayed so as to be superimposed on the “APPLE” symbols displayed on the left of the lower column, the center of the middle column, and the right of the upper column. In this example, since the three “APPLE” symbols are lined up on the payline L2, a winning combination for awarding a prize for the sub game is set to a bonus game trigger in accordance with the symbol combination table (see FIG. 5), and the main CPU 71 judges at S132 that a special winning combination of the sub game is established. The main CPU 71 then determines that a winning combination for awarding a prize for the sub game is a “bonus game trigger”, thereby determining a “bonus game” as the payout amount.

That is, the main CPU 71 executes the sub game in parallel with the main game executed with use of the reels, the sub game in which the symbol matrix is formed by arranging on the upper image display panel 131 the symbols having been rearranged in the display region of the reel assembly 3. The main CPU 71 executes the sub game every time the main game is executed with the reels the predetermined number of times (in this case, three times).

The main CPU 71 performs the payout-amount-determination processing (S133). Following S132, the main CPU 71 determines the payout amount corresponding to a prize based upon a winning combination for the sub game, with reference to the symbol combination table (see FIG. 5) stored in the RAM 73. Specifically, the main CPU 71 determines the payout amount corresponding to a prize based upon a winning combination for the sub game, in a case of determining, as a result of the judgment at S132, to award a prize relating to the sub game.

Next, the main CPU 71 performs sub-game-initialization processing (S134). That is, the main CPU 71 clears data for use in the sub game stored in the RAM 73, which is needed to be erased, after the processing at S133 has been completed or in a case of failing to judge at S132 that a winning combination for prize award is established. Specifically, the main CPU 71 performs the initialization processing by clearing the sub-game number for the sub game stored in the RAM 73, the symbol data stored in the first, second, and third symbol storage areas in the RAM 73 for the sub game, and the data concerning the payline L2 having been displayed. Upon completion of this processing, the main CPU 71 terminates the sub-game processing.

Next, reel-control processing will be explained. FIG. 16 is a flowchart showing a subroutine of the reel-control processing. First, the main CPU 71 starts rotation of each of the reels 3L, 3C, 3R by controlling the stepping motor 159 (S141).

The main CPU 71 then stops rotation of the plurality of reels 3L, 3C, 3R with reference to the symbol storage areas, by controlling the stepping motor 159 (S142). The main CPU 71 exercises control so as to display the reel assembly 3 (composed of three reels, the left reel 3L, the center reel 3C, and the right reel 3R) in a rotating state, with reference to the symbol storage areas. Upon execution of this processing, the main CPU 71 terminates the reel-control processing.

Next, the payout-amount-determination processing will be explained. FIG. 17 is a flowchart showing a subroutine of the payout-amount-determination processing. First, the main CPU 71 judges whether or not a winning combination is a jackpot (S151). The main CPU 71 then determines the payout amount corresponding to a winning combination (S152) when judging that a winning combination is not a jackpot. In a case where a winning combination is composed of the “BELL” symbols, the main CPU 71 determines the payout amount of “eight” (see FIG. 5). In a case of so-called “losing”, the payout amount is determined to be “zero”. The main CPU 71 then stores the determined payout amount in the payout amount counter (S153). Upon execution of this processing, the main CPU 71 terminates the payout-amount-determination processing.

The main CPU 71 then reports the external control unit (S154). That is, upon judging at S151 that a winning combination is a jackpot, the main CPU 71 notifies the external control unit (not shown) that a jackpot prize has been awarded. Upon receipt of the report, the external control unit transmits to the gaming machine 1 the jackpot amount having been updated up to now. At this time, part (for example, 80 percent) of the jackpot amount may be a transmission target with the remaining amount being carried over in preparation to the subsequent establishment of the jackpot trigger.

The main CPU 71 then receives the jackpot amount from the external control unit (S155). Next, the main CPU 71 stores the received jackpot amount in the payout amount counter (S156). Upon execution of this processing, the main CPU 71 terminates the payout-amount-determination processing.

Next, bonus-game processing will be explained. FIG. 18 is a flowchart showing a subroutine of the bonus-game processing. First, the main CPU 71 determines the number of bonus games, i.e., the bonus-game number (S171). In this embodiment, various bonus game numbers such as “50”, “70”, and “100” are set, and any one of them is determined.

The main CPU 71 stores the determined bonus game number in the bonus game number counter set in the RAM 73 (S172).

Like the processing at S13 described above, the main CPU 71 then performs initialization processing when one game terminates. Next, the main CPU 71 performs the symbol-determination processing shown in FIG. 11 described above (S174). The main CPU 71 then performs the processing of determining the contents of effect images (S175), in the same manner as that of S17. The main CPU 71 then performs the reel-control processing shown in FIG. 16 described above (S176). Next, the main CPU 71 performs the payout-determination processing shown in FIG. 17 described above (S177).

Next, the main CPU 71 judges whether or not a bonus game trigger has been established (S178). Upon judging that the bonus game trigger has been established, the main CPU 71 determines the bonus game number to be added (S179). Like the processing of S171 described above, the bonus game number is to be determined. The main CPU 71 then adds the determined bonus game number to the value of the bonus game number counter (S180).

Next, the main CPU 71 performs payout processing (S181). That is, the main CPU 71 performs the processing of paying out to the player after the processing at S180 has been completed or when judging at S178 that the bonus game trigger has not been established. In this processing, the main CPU 71 adds to a bonus-oriented payout amount counter, a value that is stored in the payout amount counter though the payout-amount-determination processing at S177 described above. The bonus-oriented payout amount counter is intended to control the total payout amount determined during the bonus game.

When the bonus-game processing is terminated, a value stored in the bonus-oriented payout amount counter is added to a value of the credit amount counter set in the RAM 73, in the payout processing at S23 shown in FIG. 6 described above. That is, the total payout amount determined through the bonus game is paid out in all. Incidentally, coins may be discharged from the coin payout exit 15A or a barcode-attached ticket may be issued.

The main CPU 71 subtracts the value of the bonus game number counter by 1 (S182). The main CPU 71 then judges whether or not the bonus game number counter is equal to zero (S183). Upon judging that the bonus game number counter is not equal to zero, the main CPU 71 reverts to S173. On the other hand, upon judging that the bonus game number counter is equal to zero, the main CPU 71 terminates the bonus game processing. Upon termination of the bonus game processing, the main CPU 71 reverts to S22 to perform the main-control processing shown in FIG. 6 described above.

Next, the insurance-check processing will be explained. FIG. 19 is a flowchart showing a subroutine of the insurance-check processing. First, the main CPU 71 judges whether or not the insurance-validated flag is set to ON (S191). Upon judging that the insurance-validated flag is not set to ON, the main CPU 71 terminates the insurance-check processing.

Upon judging that the insurance-validated flag is set to ON, the main CPU 71 judges whether or not the predetermined winning combination has been established (S192). In this embodiment, the predetermined winning combination is realized as the “bonus game trigger” or the “jackpot”.

Next, upon judging that the predetermined winning combination has not been established, the main CPU 71 then judges whether or not the value of the insurance-purpose game number counter reaches a threshold value (300, for example)(S193). The main CPU 71 terminates the insurance-check processing upon judging that the value of the insurance-purpose game number counter has not reached a threshold value.

Next, upon judging that the insurance-purpose game number counter has reached a threshold value, the main CPU 71 performs the payout processing based upon the insurance amount (S194). In this embodiment, a predetermined amount (200, for example) is preset as the insurance amount and added to the value of the credit amount counter.

The main CPU 71 resets the insurance-purpose game number counter (S195). That is, the main CPU 71 resets the insurance-purpose game number counter after the processing at S194 has been completed or when judging at S192 that a predetermined winning combination is established. The main CPU 71 then sets the insurance-validated flag to OFF (S196). Upon execution of this processing, the main CPU 71 terminates the insurance-check processing.

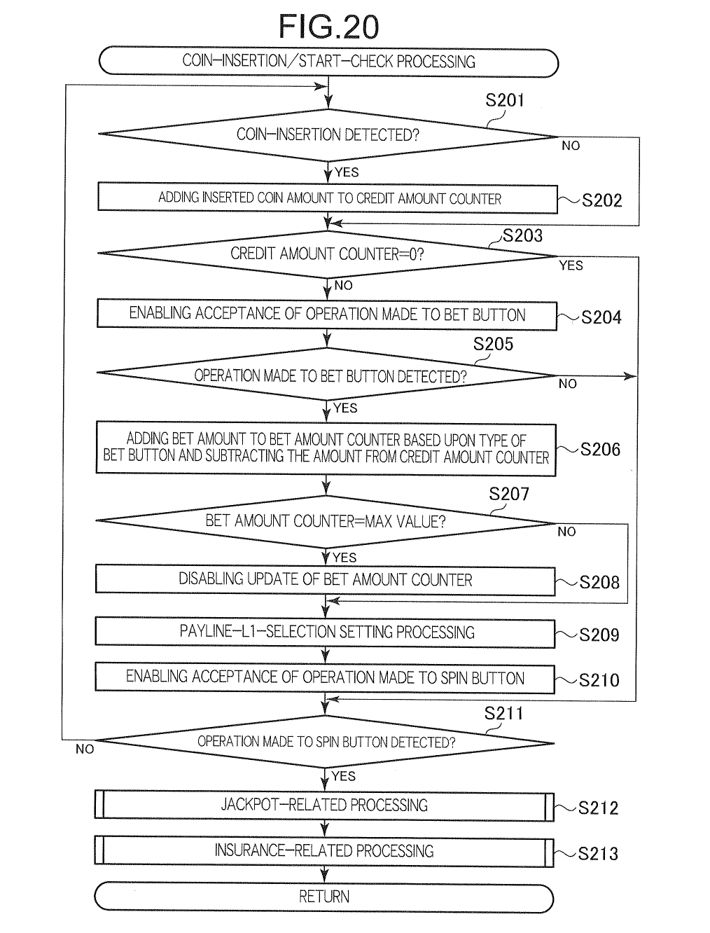

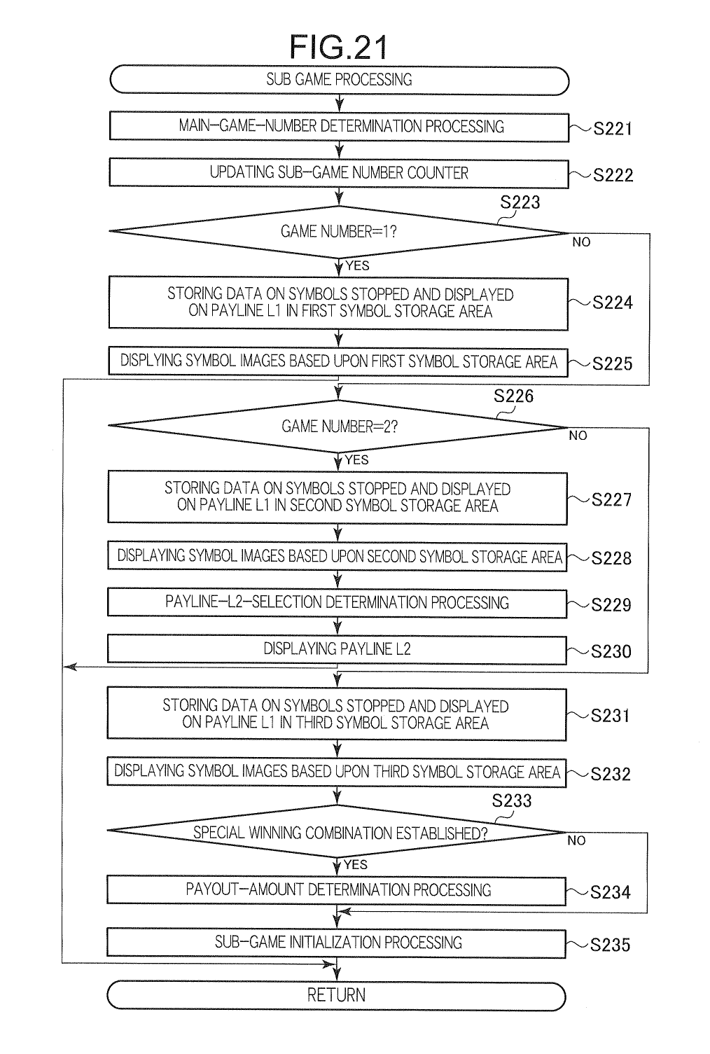

Next, another embodiment of the present invention will be explained with reference to the drawings. FIG. 20 is a flowchart showing a subroutine of coin-insertion/start-check processing. FIG. 21 is a flowchart showing a subroutine of sub-game processing. Processing other than that to be described hereinafter with reference to the drawings is substantially the same as that of the above-described embodiment of the present invention. A duplicate description is omitted hereinafter.

Next, the coin-insertion/start-check processing according to another embodiment of the present invention will be explained. FIG. 20 is a flowchart showing a subroutine of the coin-insertion/start-check processing. The processing from S41 to S48 of FIG. 8 is substantially the same as that from S201 to S208 of FIG. 20, and the processing from S50 to S53 of FIG. 8 is substantially the same as that from S210 to S213 of FIG. 20. A duplicated description is omitted hereinafter.

Payline-L1-setting processing at S229 of FIG. 21 will be explained. The main CPU 71 performs the payline-L1-setting processing (S209). The main CPU 71 selects one from among a plurality of paylines that can be set on the reel assembly 3, based upon operation through the touch panel 114 (an input device). That is, the main CPU 71 accepts selection as to which position is set for the payline L1, input through the touch panel 114, and sets and stores in the RAM 73 the payline L1 to be displayed within the display window assembly 4 in a state in which the payline is superimposed on the reel assembly 3, in accordance with the accepted selection of the payline L1. The main CPU 71 exercises control so as to accept selection of the payline L1 for each of the main games. Further, the main. CPU 71 may exercise control so as to accept selection of the payline L1 every time the sub game is terminated, that is, when the game number for the sub game is cleared to zero. That is, the main CPU 71 sets and displays the predetermined payline L1 in the display window assembly 4 as the display region of the reel assembly 3, the payline L1 having been selected based upon the selection result of the predetermined payline L1 input through the touch panel 114. The main CPU 71 stores the symbols rearranged on the payline set on the display window assembly 4 as the display region of the reel assembly 3, every time the main game is executed the predetermined number of times.

Next, sub-game processing according to another embodiment of the present invention will be described. FIG. 21 is a flowchart showing a subroutine of the sub-game processing. The processing from S222 to S228 of FIG. 21 is substantially identical to that from S121 to S127 of FIG. 12, and the processing from S230 to S235 of FIG. 21 is substantially identical to that from S129 to S134 of FIG. 12. A duplicated description is omitted hereinafter.

First, main-game-number-determination processing at S221 will be explained. The main CPU 71 performs the main-game-number-determination processing (S221). The main CPU 71 randomly determines the number of main games. Hereinafter, a case in which the randomly-determined number of main games is three will be explained. Next, the main CPU 71 updates the game number counter for the sub game (S222).

Next, payline-L2-selection-determination processing at S229 will be explained. The main CPU 71 performs the payline-selection-determination processing (S229). In this example, the predetermined number is three and the processing at S229 is performed while the game number is set to three, so that the main CPU 71 accepts from the outside through the touch panel 114 (the input device), the selection of one payline L2 from among the plurality of paylines L2 that can be set on the upper image display panel 131. The main CPU 71 sets the payline L2 which determines a winning combination (a symbol combination) for warding a special prize, on the upper image display panel 131 based upon the accepted selection of the payline L2. The main CPU 71 displays the payline L2 on the upper image display panel 131 based upon setting of the payline L2, so as to superimpose the payline L2 on the symbols. The main CPU 71 stores the data concerning the selected payline L2 in the RAM 73. That is, the main CPU 71 displays the selected payline L2 on the upper image display panel 131, based upon the selection result of the payline L2 input through the touch panel 114.

While the above example described a case in which the gaming machine is provided with a touch panel 114 as an input device, the present invention is not limitative thereto. For example, the gaming machine may be provided with another touch panel other than the touch panel 114, as the input device. For example, the gaming machine may be further provided with another touch panel as the input device so as to superimpose this touch panel on the upper image display panel 131. The payline L2 may be selected through another touch panel. The gaming machine is only required to accept input from outside.

While the above example described a case in which the sub game is executed when the main game is executed the predetermined number of times, e.g., three times, the present invention is not limitative thereto. The predetermined number may be set to one, two, four, or more. Further, the predetermined number may be randomly set.

While the above example described a case in which the payline is set when the counted game number of main games is two, the present invention is not limitative thereto. The payline may be set when the game number of main games is one, three, or more.

While the above example described a case in which the number of paylines is set to one, the present invention is not limitative thereto. The preset number of paylines may be plural, i.e., two or more.

While the above example described a case in which the payline is preset, the present invention is not limitative thereto. The payline may be randomly determined for each of the main games.

While the above example described a case in which the payline is preset, the present invention is not limitative thereto. The plural number of paylines can be set and selected by the player through the input device for allowing external output such as a touch panel or a selection button. That is, the payline to be set on the upper image display panel 131 may be predetermined from among the plurality of paylines based upon a selection input through the input device.

While the above example described a case in which the table for use in determination of pattern combinations is shared between the normal game and the sub game, the present invention is not limitative thereto. The table for determination of pattern combinations may be different between the normal game and the sub game. In that case, another table for determination of pattern combinations may be prepared for use in the sub game. Further, the plurality of tables for determination of pattern combinations may be prepared for use in the sub game, corresponding to types of combinations.

While the above example described a case in which the single payline L1 is used, the present invention is not limitative thereto. For example, the plurality of lines may be employed as the paylines, including a line connecting parts of the upper column of the display assembly 4 and a diagonal line connecting part of the upper column, part of the middle column, and part of the lower column. The shape of such payline L1 may be changed to a bent shape such as a V-letter shape or a rhombic shape, as well as a straight-line shape.

While the embodiment according to the present invention has been described, the description presents only some of the specific examples and is not intended to limit the present invention in any way and specific constructions of each means and the like can be properly changed in terms of design. Moreover, the effects described in the embodiment of the present invention are only the most preferable effects generated from the present invention and the effects to be caused by the present invention is not limitative thereto.

What is claimed is:

1. A gaming machine, comprising:
(i) a first display device that is intended for a main game and on which plural types of symbols are rearranged in a display region every time the main game is executed;
(ii) a second display device that is intended for a sub game; forms a symbol matrix in association with an arrangement outcome of the symbols rearranged in the display region on the first display device, every time the main game is executed on the first display device a predetermined number of times; and shows an outcome of the sub game by displaying a payline on the symbol matrix;
(iii) a memory that stores data concerning the symbols rearranged in the display region on the first display device, every time the main game is executed the predetermined number of times, and stores a game number as a number of times that the main game is executed; and
(iv) a controller, the contorller being configured to:
(a) execute the main game in which the plural types of symbols are rearranged in the display region on the first display device;
(b) determine whether to award a first prize in accordance with a displayed outcome of the plural types of symbols rearranged in the process (a), in the display region on the first display device;
(c) award the first prize as a prize for the main game, in a case where the the first prize is determined to be awarded as a result of the process (b), and then activate a subsequent main game; or
activate the subsequent main game, in a case where the first prize is determined not to be awarded as a result of the process (b);
(d) execute the sub game in parallel with the main game executed in the processes (a) to (c) on the first display device, the sub game in which the symbol matrix is formed by arranging in the second display device based upon the data stored in the memory, the symbols rearranged in the display region on the first display device every time the main game is executed on the first display device the predetermined number of times;
(e) judge based upon data concerning the game number stored in the memory, whether the predetermined number of main games executed in the processes (a) to (c) have been executed;
(f) display the payline on the symbol matrix of the second display device during a period from execution of the at least one or more main games to execution of the predetermined number of main games, upon judging that the predetermined number of main games have been executed;
(g) judge whether the symbols for awarding a second prize are displayed on the payline on the symbol matrix of the second display device;
(h) award the second prize as a prize for the sub game, upon judging as a result of the process (g) that the second prize is to be awarded; and
(i) initialize the game number for the main game, stored in the memory.

2. The gaming machine according to claim 1, wherein:
the controller displays the payline on the symbol matrix of the second display device during a period from completion of execution of one less than the predetermined number of main games to display of an outcome of the predetermined number of main games, upon judging in the process (f) that the predetermined number of main games have been executed.

3. The gaming machine according to claim 1, wherein:
the controller stores in the memory, a result of random determination of the predetermined number of main games; and executes the sub game in the process (d) based upon the predetermined number of main games stored in the memory, in parallel with the main game executed on the first display device in the processes (a) to (c).

4. The gaming machine according to claim 1, wherein:
the controller:
randomly predetermines a given payline from among the plurality of paylines that are settable on the symbol matrix of the second display device; and
executes the process (f) so as to display the randomly-predetermined given payline on the symbol matrix of the second display device.

5. The gaming machine according to claim 1, further comprising:
an input device for selecting a given payline from among the plurality of paylines that are settable on the second display device, wherein:
the controller executes the process (f) based upon a result of the selection of the given payline by the input device, so as to display the selected given payline on the symbol matrix of the second display device.

6. The gaming machine according to claim 1, wherein:
the controller:
predetermines a given payline to be set on the first display device;
sets the predetermined given payline on the first display device;
stores the symbols rearranged on the payline set on the display region on the first display device, every time the main game is executed the predetermined number of times; and
executes the sub game in the process (d) in parallel with the main game executed in the processes (a) to (c) on the first display device, the sub game in which the symbol matrix is formed by arranging in the second display device based upon the data stored in the memory, the symbols rearranged on the payline set on the display region on the first display device every time the main game is executed on the first display device the predetermined number of times.

7. The gaming machine according to claim 1, further comprising:
an input device for selecting a given payline from among the plurality of paylines that are settable on the first display device, wherein:
the controller:
sets the selected given payline on the display region of the first display device, based upon a result of the selection of the given payline by the input device;
stores in the memory the symbols rearranged on the payline set on the display region on the first display device, every time the main game is executed the predetermined number of times; and
executes the sub game in the process (d) in parallel with the main game executed in the processes (a) to (c) on the first display device, the sub game in which the symbol matrix is formed by arranging in the second display device based upon the data stored in the memory, the symbols rearranged on the payline set on the display region on the first display device every time the main game is executed on the first display device the predetermined number of times.

8. A gaming machine, comprising:
(i) a first display device that is intended for a main game and on which plural types of symbols are rearranged in a display region every time the main game is executed;
(ii) a second display device that is intended for a sub game; forms a symbol matrix in association with an arrangement outcome of the symbols rearranged in the display region on the first display device, every time the main game is executed on the first display device a predetermined number of times; and shows an outcome of the sub game by displaying a payline on the symbol matrix;
(iii) a memory that stores data concerning the symbols rearranged in the display region on the first display device, every time the main game is executed the predetermined number of times, and stores a game number as a number of times that the main game is executed; and
(iv) a controller, the contorller being configured to:
(a) execute the main game in which the plural types of symbols are rearranged in the display region on the first display device;
(b) determine whether to award a first prize in accordance with a displayed outcome of the plural types of symbols rearranged in the process (a), in the display region on the first display device;
(c) award the first prize as a prize for the main game, in a case where the the first prize is determined to be awarded as a result of the process (b), and then activate
a subsequent main game; or activate the subsequent main game, in a case where the first prize is determined not to be awarded as a result of the process (b);
(d) execute the sub game in parallel with the main game executed in the processes (a) to (c) on the first display device, the sub game in which the symbol matrix is formed by arranging in the second display device based upon the data stored in the memory, the symbols rearranged in the display region on the first display device every time the main game is executed on the first display device the predetermined number of times;
(e) judge based upon data concerning the game number stored in the memory, whether the predetermined number of main games executed in the processes (a) to (c) have been executed;
(f) display the payline on the symbol matrix of the second display device during a period from completion of execution of main games whose number is one less than the predetermined number to display of an outcome of the predetermined number of main games, upon judging that the predetermined number of main games have been executed;
(g) judge whether the symbols for awarding a second prize are displayed on the payline on the symbol matrix of the second display device;
(h) award the second prize as a prize for the sub game, upon judging that the second prize is awarded, as a result of the processes (g); and
(i) initialize the game number for the main game, stored in the memory.

9. The gaming machine according to claim 8, wherein:
the controller:
stores in the memory, a result of random determination of the predetermined number of main games; and
executes the sub game in the process (d) based upon the predetermined number of main games stored in the memory, in parallel with the main game executed on the first display device in the processes (a) to (c).

10. The gaming machine according to claim 8, wherein:
the controller:
randomly predetermines a given payline from among the plurality of paylines that can be set on the symbol matrix of the second display device; and
executes the process (f) so as to display the randomly-predetermined given payline on the symbol matrix of the second display device.

11. The gaming machine according to claim 8, further comprising:
an input device for selecting a given payline from among the plurality of paylines that can be set on the second display device, wherein:
the controller executes the process (f) based upon a result of the selection of the given payline by the input device, so as to display the selected given payline on the symbol matrix of the second display device.

12. The gaming machine according to claim 8, wherein:
the controller:
predetermines a given payline to be set on the first display device;
sets the predetermined given payline on the first display device;
stores the symbols rearranged on the payline set in the display region on the first display device, every time the main game is executed the predetermined number of times; and
executes the sub game in the process (d) in parallel with the main game executed in the processes (a) to (c) on the first display device, the sub game in which the symbol matrix is formed by arranging in the second display device based upon the data stored in the memory, the symbols rearranged on the payline set on the display region on the first display device every time the main game is executed on the first display device the predetermined number of times.

13. The gaming machine according to claim 8, further comprising:
an input device for selecting a given payline from among the plurality of paylines that are settable on the first display device, wherein:
the controller:
sets the selected given payline on the display region of the first display device, based upon a result of the selection of the given payline by the input device;
stores in the memory the symbols rearranged on the payline set on the display region on the first display device, every time the main game is executed the predetermined number of times; and
executes the sub game in the process (d) in parallel with the main game executed in the processes (a) to (c) on the first display device, the sub game in which the symbol matrix is formed by arranging in the second display device based upon the data stored in the memory, the symbols rearranged on the payline set on the display region on the first display device every time the main game is executed on the first display device the predetermined number of times.

14. A gaming machine, comprising:
(i) a first display device that is intended for a main game and on which plural types of symbols are rearranged in a display region every time the main game is executed;
(ii) a second display device that is intended for a sub game; form a symbol matrix in association with an arrangement outcome of the symbols rearranged in the display region on the first display device, every time the main game is executed on the first display device a predetermined number of times; and shows an outcome of the sub game by displaying a payline on the symbol matrix;
(iii) a memory that stores data concerning the symbols rearranged in the display region on the first display device, every time the main game is executed the predetermined number of times, and stores a game number as a number of times that the main game is executed; and
(iv) a controller, the contorller being configured to:
(a) randomly determine the game number for the main game executed on the first display device, and stores the determined game number in the memory;
(b) execute the main game in which the plural types of symbols are rearranged in the display region on the first display device;
(c) determine whether to award a first prize in accordance with a displayed outcome of the plural types of symbols rearranged in the process (b), in the display region on the first display device;
(d) award the first prize as a prize for the main game, in a case where the the first prize is determined to be awarded as a result of the process (c), and then activate a subsequent main game; or
activate the subsequent main game, in a case where the first prize is determined not to be awarded as a result of the process (c);
(e) execute the sub game in parallel with the main game executed in the processes (b) to (d) on the first display device, the sub game in which the symbol matrix is formed by arranging in the second display device based upon the data stored in the memory, the symbols rearranged in the display region on the first display device every time the main game is executed on the first display device the predetermined number of times;
(f) judge based upon data concerning the game number stored in the memory, whether the predetermined number of main games executed in the processes (b) to (d) have been executed;
(g) display the payline on the symbol matrix of the second display device during a period from execution of the at least one or more main games to execution of the predetermined number of main games, upon judging that the predetermined number of main games have been executed;
(h) judge whether the symbols for awarding a second prize are displayed on the payline on the symbol matrix of the second display device;
(i) award the second prize as a prize for the sub game, upon judging as a result of the process (g) that the second prize is to be awarded; and
(j) initialize the game number for the main game, stored in the memory.

15. The gaming machine according to claim 14, wherein:
the controller displays the payline on the symbol matrix of the second display device during a period from completion of execution of one less than the predetermined number of main games to display of an outcome of the predetermined number of main games, upon judging in the process (g) that the predetermined number of main games have been executed.

16. The gaming machine according to claim 14, wherein:
the controller:
randomly predetermines a given payline from among the plurality of paylines that are settable on the symbol matrix of the second display device; and
executes the process (g) so as to display the randomly-predetermined given payline on the symbol matrix of the second display device.

17. The gaming machine according to claim 14, further comprising:
an input device for selecting a given payline from among the plurality of paylines that are settable on the second display device, wherein:
the controller executes the process (f) based upon a result of the selection of the given payline by the input device, so as to display the selected given payline on the symbol matrix of the second display device.

18. The gaming machine according to claim 14, wherein:
the controller:
predetermines a given payline to be set on the first display device;
sets the predetermined given payline on the first display device;
stores the symbols rearranged on the payline set on the display region on the first display device, every time the main game is executed the predetermined number of times; and
executes the sub game in the process (e) in parallel with the main game executed in the processes (b) to (d) on the first display device, the sub game in which the symbol matrix is formed by arranging in the second display device based upon the data stored in the memory, the symbols rearranged on the payline set on the display region on the first display device the main game is executed on the first display device the predetermined number of times.

19. The gaming machine according to claim 14, further comprising:
an input device for selecting a given payline from among the plurality of paylines that are settable on the first display device, wherein:
the controller:
sets the selected given payline on the display region of the first display device, based upon a result of the selection of the given payline by the input device;
stores in the memory the symbols rearranged on the payline set on the display region on the first display device, every time the main game is executed the predetermined number of times; and
executes the sub game in the process (e) in parallel with the main game executed in the processes (b) to (d) on the first display device, the sub game in which the symbol matrix is formed by arranging in the second display device based upon the data stored in the memory, the symbols rearranged on the payline set on the display region on the first display device every time the main game is executed on the first display device the predetermined number of times.
